(19) United States
(12) Patent Application Publication
(10) Pub. No.: US 2010/0238819 A1
(43) Pub. Date: Sep. 23, 2010

(54) RELAYING METHOD, TRANSMITTER, RECEIVER AND RELAY

(75) Inventors: Tetsuya UEHORI, Fukuoka (JP); Akio Yonehara, Fukuoka (JP); Kenichi Takeshita, Fukuoka (JP); Hirofumi Mitome, Fukuoka (JP); Masayoshi Nakano, Fukuoka (JP); Takashi Ikeda, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/685,338

(22) Filed: Jan. 11, 2010

(30) Foreign Application Priority Data
Mar. 17, 2009 (JP) 2009-065125

(51) Int. Cl. H04L 12/26; H04L 12/56

(52) U.S. Cl. 370/252; 370/400

(57) ABSTRACT

A relaying method includes a request packet generation operation generates a request packet for requesting a connectivity check for all communication routes between said receiver and said transmitter, a request packet transmission operation transmits a generated request packet to a relay, a route information addition operation adds information representing the router itself to the received request packet as route information, a request packet forwarding operation forwards the request packet to which said route information has been added to each of all the communication routes between said receiver and said relay, a response packet generation operation has been transcribed, a response packet transmission operation in which said receiver transmits the generated response packet to said transmitter via said relay, a response packet forwarding operation forwards the received response packet to said transmitter, and a route information output operation outputs the route information included in the received response packet.

### CROSS-REFERENCE TO RELATED APPLICATIONS

This application is based upon and claims the benefit of priority of the prior Japanese Patent Application No. 2009-65125, filed on Mar. 17, 2009, the entire contents of which are incorporated herein by reference.

### FIELD

The present invention relates to a relaying method, a transmitter, a receiver and a relay relaying packets between the transmitter and the receiver, which are connected to each other through a plurality of communication routes. For example, the present invention relates to a relaying method, a transmitter, a receiver and a relay enabling verification of the connectivity status not only of a communication route being operated but also of an auxiliary communication route.

### BACKGROUND

Methods for checking a network condition include a connectivity check by Packet Internet Grouper (Ping). Ping is a command for verifying whether or not a device on the other end is a state that enables communication. When Ping is executed, an Internet Control Message Protocol (ICMP) packet is propagated according to a routing protocol shared by network equipment on the communication route. Then, by verifying that the ICMP packet reaches the target equipment, the status of the equipment and the intermediate communication route can be determined to be normal.

JP-A-2006-67081 discloses a method in which a monitoring system establishes communications using Ping between a pair of nodes on a network, and if there is no response within a given time, switches from a route being operated to an auxiliary route.

### SUMMARY

According to an aspect of the invention, a relaying method includes a request packet generation operation in which a transmitter generates a request packet for requesting a connectivity check for all communication routes between a receiver and a transmitter, a request packet transmission operation in which the transmitter transmits a generated request packet to a relay, a route information addition operation in which, when the request packet transmitted by the transmitter is received, the relay adds information representing the router itself to the received request packet as route information, a request packet forwarding operation in which the relay forwards the request packet to which the route information has been added to each of all the communication routes between the receiver and the relay, a response packet generation operation in which, when the request packet forwarded by the relay is received, the receiver generates a response packet into which the route information included in the received request packet has been transcribed, a response packet transmission operation in which the receiver transmits the generated response packet to the transmitter via the relay, a response packet forwarding operation in which, when the response packet transmitted by the receiver is received, the relay forwards the received response packet to the transmitter, and a route information output operation in which, when the response packet forwarded by the relay is received, the transmitter outputs the route information included in the received response packet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

The above-described embodiments of the present invention are intended as examples, and all embodiments of the present invention are not limited to including the features described above.

### BRIEF DESCRIPTION OF THE DRAWINGS

FIG. 1 is a diagram showing an overall configuration of a network system according to an embodiment;

FIG. 2A is a diagram (1) illustrating an overview of a transmitting terminal;

FIG. 2B is a diagram (2) illustrating an overview of the transmitting terminal;

FIG. 3 is a functional block diagram showing a configuration of the transmitting terminal;

FIG. 4 is a flowchart showing processing procedure in the transmitting terminal when an all-routes verification request packet is transmitted;

FIG. 5A is a diagram showing an example of a command displayed by a user interface section;

FIG. 5B is a diagram showing an example of PING transmission type definition data;

FIG. 6A is a diagram showing an example of the all-routes verification request packet generated by the transmitting terminal;

FIG. 6B is a diagram showing an example of timer management data;

FIG. 7 is a diagram showing an example of a buffer area reserved in an all-routes response buffer storage section;

FIG. 8 is a flowchart showing processing procedure in the transmitting terminal when an all-routes verification response packet is received;

FIG. 9A is a diagram showing an example of the all-routes verification response packet received by the transmitting terminal;

FIG. 9B is a diagram showing an example of storage of information in the buffer area reserved in the all-routes response buffer storage section;

FIG. 10 is a diagram showing an example of a data storage buffer displayed by a PING event display processing section;

FIG. 11 is a flowchart showing processing procedure of timeout processing in the transmitting terminal after the all-routes verification request packet is transmitted;

FIG. 12 is a diagram showing an example of a message indicating that there is no response;

FIG. 13 is a diagram illustrating an overview of a receiving terminal;

FIG. 14 is a functional block diagram showing a configuration of the receiving terminal;

FIG. 15 is a flowchart showing processing procedure in the receiving terminal from the reception of the all-routes verification request packet to the transmission of the all-routes verification response packet;

FIG. 16 is a diagram showing an example of the all-routes verification request packet received by the receiving terminal;

FIG. 17 is a diagram showing an example of the all-routes verification response packet generated by a PING packet generation processing section of the receiving terminal;

FIG. 18 is a functional block diagram showing a configuration of a router;

FIG. 19 is a flowchart showing processing procedure in the router for forwarding the all-routes verification request packet or the all-routes verification response packet;

FIG. 20 is a flowchart showing processing procedure of all-routes specification processing shown in FIG. 16;

FIG. 21 is a flowchart showing processing procedure of packet generation processing shown in FIG. 20;

FIG. 22 is a flowchart showing processing procedure of packet reply processing shown in FIG. 19;

FIG. 23 is a diagram illustrating a first example of packet forwarding according to the embodiment;

FIGS. 24A and 24B are sequence diagrams showing the first example of packet forwarding according to the embodiment;

FIG. 25 is a diagram illustrating a second example of packet forwarding according to the embodiment;

FIGS. 26A to 26C are sequence diagrams (1) showing the second example of packet forwarding according to the embodiment;

FIGS. 27A to 27C are sequence diagrams (2) showing the second example of packet forwarding according to the embodiment;

FIG. 28 is a diagram showing an example of route information displayed based on an ICMP packet shown in FIGS. 26A to 26C and 27A to 27C;

FIG. 29 is a diagram (1) illustrating effects according to the embodiment; and

FIG. 30 is a diagram (2) illustrating effects according to the embodiment.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

However, there is a problem that, with a connectivity check by Ping, the connectivity status of a communication route being operated using an arbitrary routing protocol can be verified, but the connectivity status cannot be verified for an auxiliary communication route. This is because for a general routing protocol, if a network has a plurality of communication routes, an ICMP packet is propagated through an optimal communication route determined based on costs and the like. The connectivity status of an auxiliary communication route is not verified also with the well known technique described above.

The disclosed technique has been conceived in view of the above respects, and in one embodiment a relaying method, a transmitter, a receiver and a relay enabling verification of the connectivity status is provided not only of a communication route being operated but also of an auxiliary communication route.

According to an aspect, a relaying method disclosed in the present application is a relaying method for relaying a packet between a transmitter and a receiver connected to each other through a plurality of communication routes. The relaying method comprises a request packet generation operation in which the transmitter generates a request packet for requesting a connectivity check for all communication routes between the receiver and the transmitter; a request packet transmission operation in which the transmitter transmits a generated request packet to the relay; a route information addition operation in which, when the request packet transmitted by the transmitter is received, the relay adds information representing the router itself to the received request packet as route information; a request packet forwarding operation in which the relay forwards the request packet to which the route information has been added to each of all the communication routes between the receiver and the relay; a response packet generation operation in which, when the request packet forwarded by the relay is received, the receiver generates a response packet into which the route information included in the received request packet has been transcribed; a response packet transmission operation in which the receiver transmits the generated response packet to the transmitter via the relay; a response packet forwarding operation in which, when the response packet transmitted by the receiver is received, the relay forwards the received response packet to the transmitter; and a route information output operation in which, when the response packet forwarded by the relay is received, the transmitter outputs the route information included in the received response packet.

In addition, according to another aspect, a transmitter disclosed in the present application comprises a request packet generator for generating a request packet for requesting a connectivity check for all communication routes between a receiver and the transmitter; a request packet transmitter for transmitting the request packet generated by the request packet generator to a relay; and a route information output section for, when the response packet forwarded by the relay is received, outputting the route information included in the received response packet.

In addition, according to another aspect, a receiver disclosed in the present application comprises a response packet generator for, when a request packet is received for requesting a connectivity check for all communication routes between the receiver and a transmitter, generating a response packet into which the route information included in the received request packet has been transcribed; and a response packet transmitter for transmitting the response packet generated by the response packet generator to the transmitter via a relay.

In addition, according to another aspect, a relay disclosed in the present application comprises a route information adder for, when the request packet transmitted by a transmitter is received, adding information representing the router itself to the received request packet as route information; a request packet forwarder for forwarding the request packet to which the route information has been added by the route information adder to each of all the communication routes between a receiver and the relay; and a response packet forwarder for, when the response packet is received into which the route information included in the request packet forwarded by the request packet forwarder has been transcribed, forwarding the received response packet to the transmitter.

According to an aspect of a relaying method disclosed in the present application, an effect is produced that allows a connectivity status to be verified not only for a communication route being operated but also for an auxiliary communication route.

An embodiment of a relaying method, a transmitter, a receiver and a relay disclosed in the present application will be described below in detail with reference to the drawings. Although the following describes an embodiment for the case where the technique disclosed in the present application is applied to a network system having a transmitter, a receiver and a plurality of routers, the present invention is not limited by the embodiment.

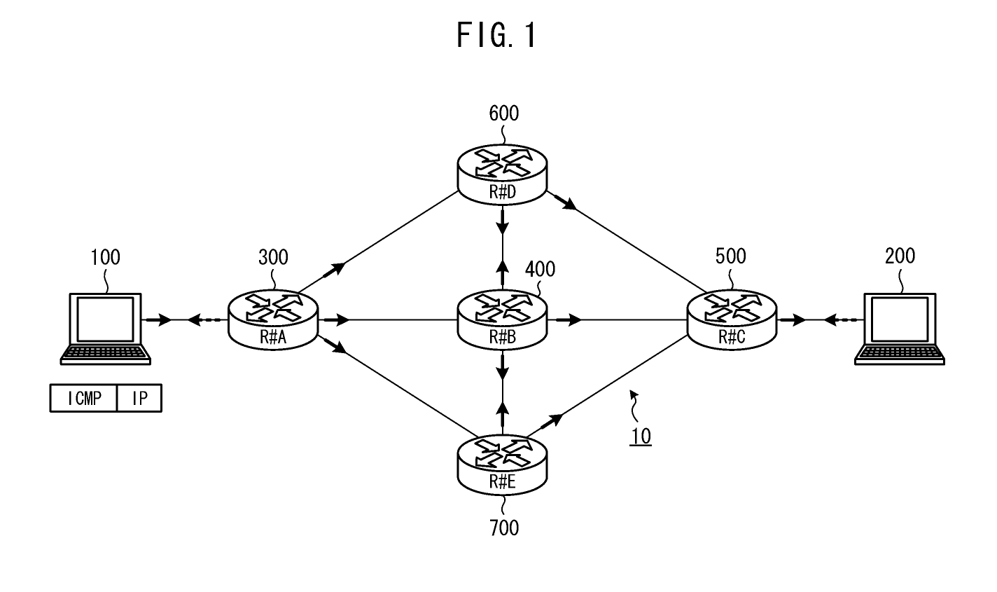

First, an overall configuration of the network system according to the embodiment will be described. FIG. 1 is a diagram showing an overall configuration of the network system according to the embodiment. As shown in FIG. 1, the network system according to the embodiment has a transmitting terminal 100, a receiving terminal 200, and routers 300 to 700.

The transmitting terminal 100 and the receiving terminal 200 are connected so that they can communicate with each other through an IP network 10 including the routers 300 to 700. Specifically, the transmitting terminal 100 is connected to the router 300, and the receiving terminal 200 is connected to the router 500. Further, the router 300 and the router 500 are connected to the routers 400, 600 and 700, respectively. Moreover, the router 400 is connected to the routers 600 and 700, in addition to the routers 300 and 500.

According to the embodiment, in the network system having the configuration described above, an ICMP packet for all-routes verification is subjected to a round-trip on all the communication routes connecting the transmitting terminal 100 and the receiving terminal 200. Consequently, according to the embodiment, a connectivity status can be verified not only for a communication route being operated but also for an auxiliary communication route. The transmitting terminal 100, the receiving terminal 200, and the routers 300 to 700 shown in FIG. 1 will be described below.

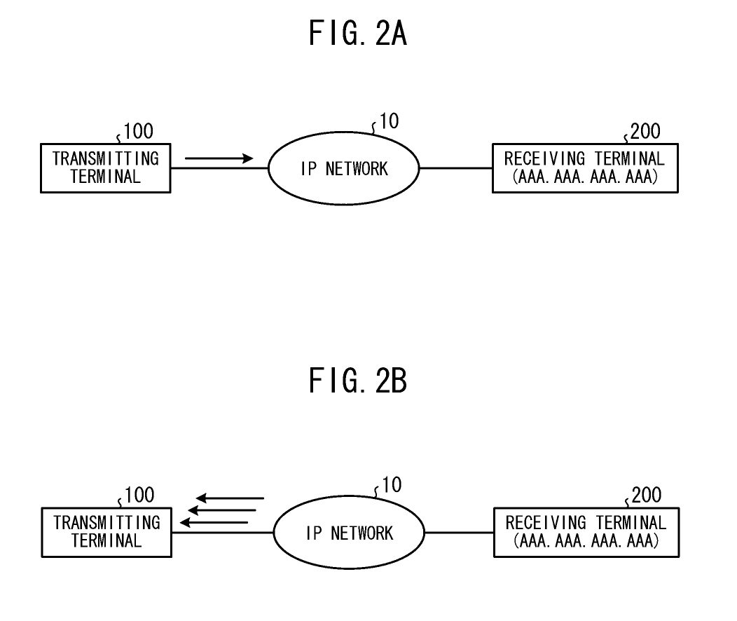

First, the overview of the transmitting terminal 100 will be described. FIGS. 2A and 2B are diagrams illustrating an overview of the transmitting terminal 100. As shown in FIG. 2A, the transmitting terminal 100 executes a Ping command to transmit an ICMP packet to the IP network 10 for requesting a connectivity check for all communication routes between the receiving terminal 200 and the transmitting terminal 100. Further, as shown in FIG. 2B, the transmitting terminal 100 receives, as a response to the transmitted ICMP packet, an ICMP packet transmitted by the receiving terminal 200 via the IP network 10.

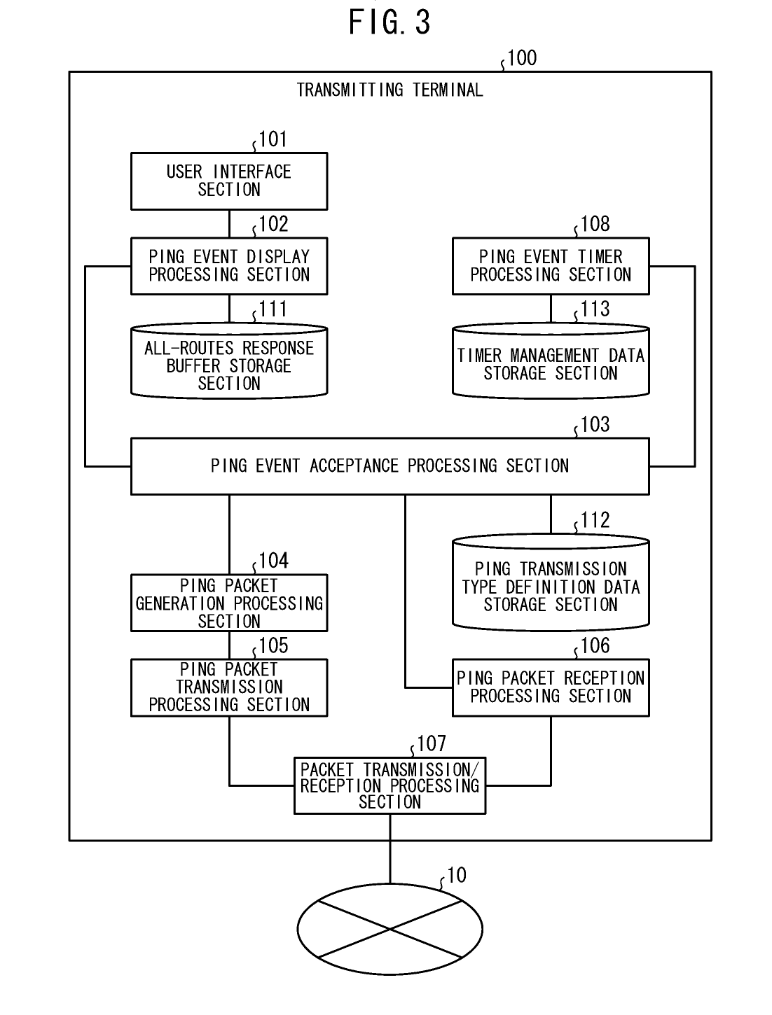

The ICMP packet for requesting a connectivity check is hereinafter referred to as an “all-routes verification request packet”. In addition, the ICMP packet transmitted by the receiving terminal 200 as a response to the all-routes verification request packet is referred to as an “all-routes verification response packet”. Further, it is assumed that the address of the receiving terminal 200 is “AAA.AAA.AAA.AAA” as shown in FIGS. 2B and 3.

Next, a configuration of the transmitting terminal 100 will be described. FIG. 3 is a functional block diagram showing a configuration of the transmitting terminal 100. As shown in FIG. 3, the transmitting terminal 100 has a user interface section 101, a PING event display processing section 102, a PING event acceptance processing section 103 and a PING packet generation processing section 104. The transmitting terminal 100 also has a PING packet transmission processing section 105, a PING packet reception processing section 106, a packet transmission/reception processing section 107 and a PING event timer processing section 108. Moreover, the transmitting terminal 100 has an all-routes response buffer storage section 111, a PING transmission type definition data storage section 112, and a timer management data storage section 113.

Next, the function of each section owned by the transmitting terminal 100 shown in FIG. 3 will be described. Here, the function of each section will be described divided into processing when an all-routes verification request packet is transmitted shown in FIG. 2A, processing when an all-routes verification response packet is received shown in FIG. 2B and timeout processing after the all-routes verification request packet is transmitted.

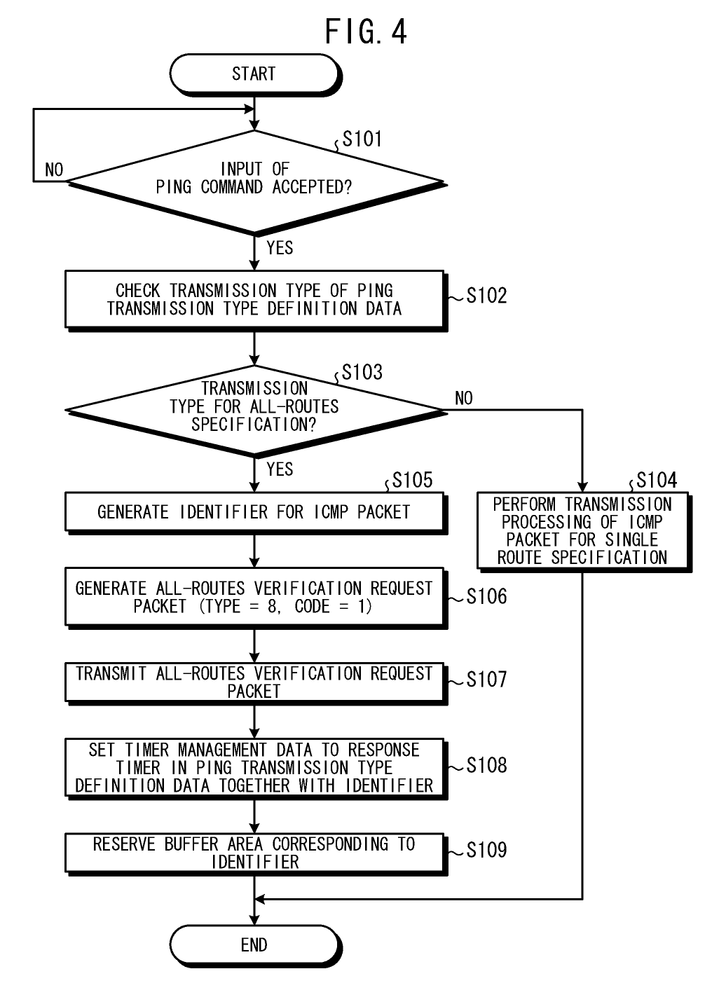

First, processing in the transmitting terminal 100 when an all-routes verification request packet is transmitted will be described. FIG. 4 is a flowchart showing processing procedure in the transmitting terminal 100 when an all-routes verification request packet is transmitted. As shown in FIG. 4, in the transmitting terminal 100, the user interface section 101 first accepts the input of a PING command from a user through an input device such as a keyboard and a mouse.

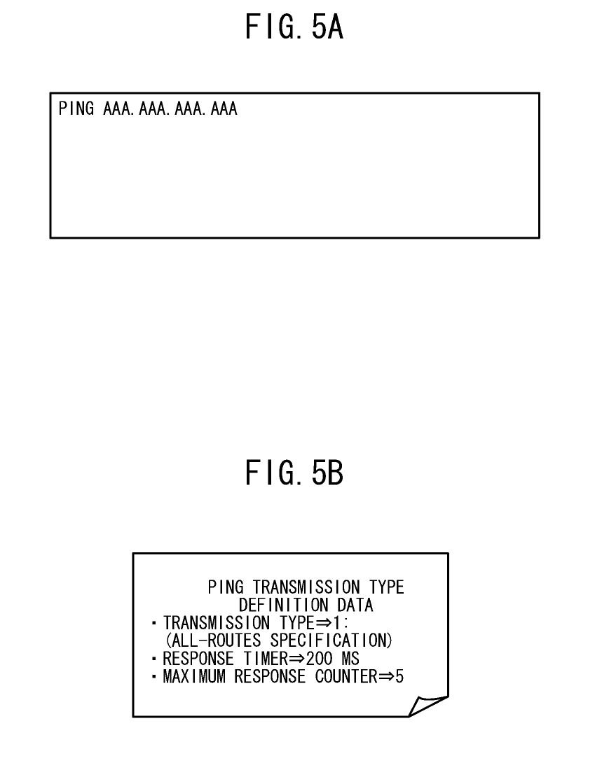

Upon accepting the input of the Ping command from the user (operation S101, Yes), the user interface section 101 displays various input commands on a display unit such as a display. FIG. 5A is a diagram showing an example of a command displayed by the user interface section 101. As shown in FIG. 5A, for example, when a request to execute the Ping command is accepted from the user, “Ping AAA.AAA.AAA.AAA” is displayed by the user interface section 101. In this case, “AAA.AAA.AAA.AAA” represents the address of the receiving terminal 200.

Returning to FIG. 4, when the user interface section 101 accepts the request to execute the Ping command, the PING event display processing section 102 activates the PING event acceptance processing section 103. When activated by the PING event display processing section 102, the PING event acceptance processing section 103 refers to PING transmission type definition data stored by the PING transmission type definition data storage section 112 to check for the type of transmission (operation S102).

The PING transmission type definition data will now be described. FIG. 5B is a diagram showing an example of PING transmission type definition data. As shown in FIG. 5B, setting values for each of a “transmission type”, a “response timer” and a “maximum response counter” are included in the PING transmission type definition data. Each setting value is determined in advance before the transmitting terminal is used, and stored in the PING transmission type definition data storage section 112.

In the transmission type, a value indicating that a conventional ICMP packet for single route specification is generated, or a value indicating that an ICMP packet for all-routes specification is generated is set when a PING command is executed. For example, in the transmission type, “0” is set for the conventional single route specification, and “1” is set for the all-routes specification. The response timer is set to a predetermined time, for example “200 ms”. The maximum response counter is set to a predetermined numeric value, for example “5”. Usage of the setting values of the response timer and the maximum response counter will be described later.

Returning to FIG. 4, if the value of the transmission type is not for all-routes specification (operation S103, No), the PING event acceptance processing section 103 performs transmission processing of the ICMP packet for single route specification (operation S104), and finishes the processing. Since the transmission processing of the ICMP packet for single route specification is well known, the description thereof is omitted herein.

On the other hand, if the value of the transmission type is for all-routes specification (operation S103, Yes), the PING event acceptance processing section 103 requests the PING packet generation processing section 104 to generate an all-routes verification request packet as an ICMP packet for all-routes specification. When requested to generate the all-routes verification request packet, the PING packet generation processing section 104 first generates an identifier for ICMP packet (operation S105). Then, the PING packet generation processing section 104 uses the generated identifier to generate the all-routes verification request packet shown in FIG. 5B (operation S106).

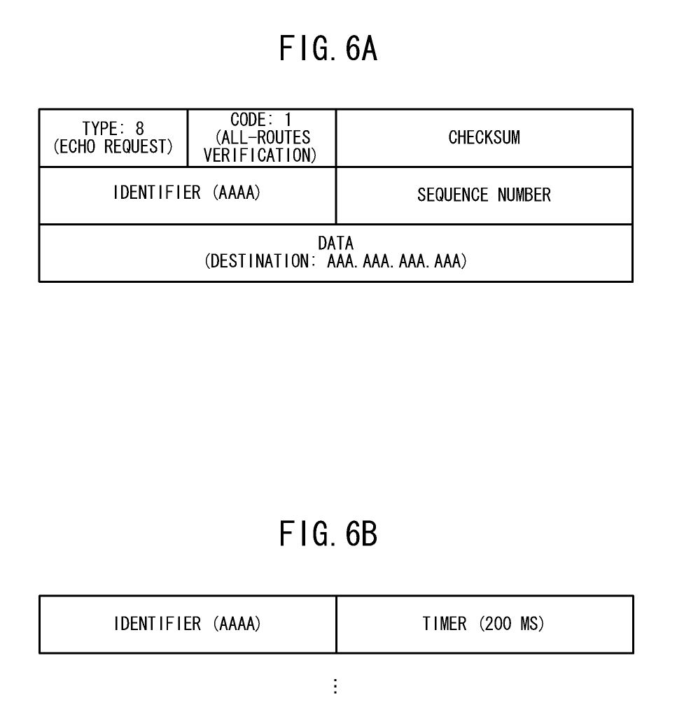

The all-routes verification request packet generated by the transmitting terminal 100 will now be described. FIG. 6A is a diagram showing an example of the all-routes verification request packet generated by the transmitting terminal 100. FIG. 6A shows the layout of a typical ICMP packet. As shown in FIG. 6A, setting values of the “type”, “code”, “checksum”, “identifier”, “sequence number” and “data” are included in the ICMP packet.

For an all-routes verification request packet, the type is set to “8”. Further, the code is set to “1”. The identifier is set to identification information for associating the all-routes verification request packet with the all-routes verification response packet generated by the same Ping command. For example, the identifier is set to “aaaa”. The sequence number is set to a number that indicates for each identifier how many packets have been transmitted.

The data is set to various information. For an all-routes verification request packet, the data is set to a destination address when a packet is generated. For example, the data is set to “AAA.AAA.AAA.AAA”, which is the address of the receiving terminal 200. As will be described in detail later, each time the packet passes through the routers 300 to 700, in addition to the destination address, the addresses of reception interfaces and transmission interfaces of routers through which the packet has passed are sequentially added to the data in the all-routes verification request packet as route information.

Returning to FIG. 4, the PING packet generation processing section 104 transmits the generated all-routes verification request packet to the PING packet transmission processing section 105. The PING packet transmission processing section 105 transmits the all-routes verification request packet transmitted from the PING packet generation processing section 104 to the network 10 via the packet transmission/reception processing section 107 (operation S107).

After transmitting the all-routes verification request packet to the PING packet transmission processing section 105, the PING packet generation processing section 104 passes the generated identifier to the PING event acceptance processing section 103. Upon accepting the identifier, the PING event acceptance processing section 103 passes the accepted identifier to the PING event timer processing section 108. Upon accepting the identifier, the PING event timer processing section 108 causes the timer management data storage section 113 to store as timer management data, the information associating the setting value of the response timer set in the PING transmission type definition data with the identifier (operation S108).

The timer management data will now be described. FIG. 6B is a diagram showing an example of timer management data. As shown in FIG. 6B, the timer management data is data associating the “identifier” with the “timer”. The identifier is set to the same value as that of the identifier that the all-routes verification request packet was set to. The timer is set to, as an initial value, the setting value of the response timer stored in the PING transmission type definition data storage section 112. Then, the value set for the timer is subtracted with a predetermined period. The subtraction of the timer will be described in detail later.

Returning to FIG. 4, after passing the identifier to the PING event timer processing section 108, the PING event acceptance processing section 103 passes the identifier to the PING event display processing section 102. Upon accepting the identifier, the PING event display processing section 102 reserves a buffer area corresponding to the accepted identifier in the all-routes response buffer storage section 111 (operation S109), and finishes the processing.

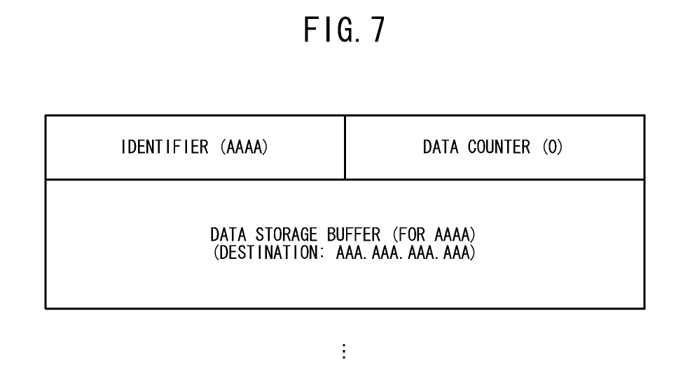

The buffer area reserved in the all-routes response buffer storage section 111 will now be described. FIG. 7 is a diagram showing an example of a buffer area reserved in the all-routes response buffer storage section 111. As shown in FIG. 7, the buffer area reserved in the all-routes response buffer storage section 111 includes an “identifier”, a “data counter” and a “data storage buffer”.

The identifier is set to the same value as that of the identifier that the all-routes verification request packet was set to. The data counter is set to “0” as an initial value. Although the data storage buffer is not set to anything at this point of time, it is set to the route information included in the all-routes response packet later, when an all-routes response packet is forwarded via the IP network 10. The setting of values for the data counter and data storage buffer will be described in detail later.

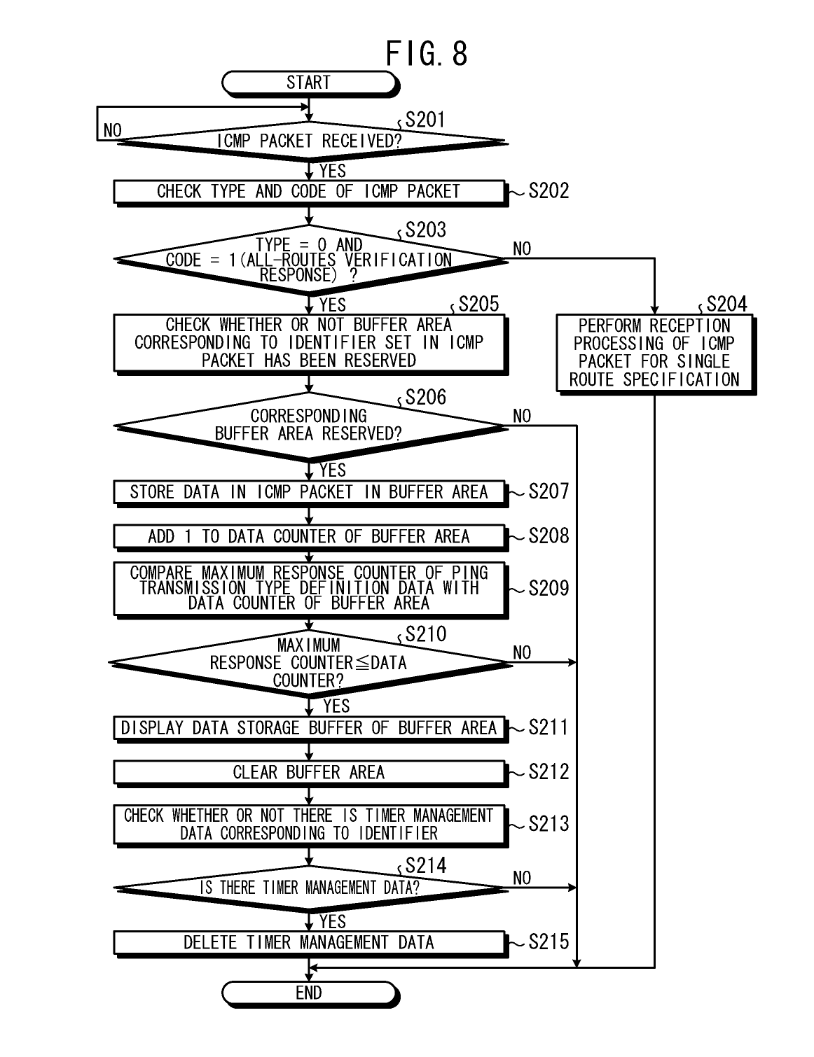

Next, processing in the transmitting terminal 100 when an all-routes verification response packet is received will be described. FIG. 8 is a flowchart showing processing procedure in the transmitting terminal 100 when an all-routes verification response packet is received. As shown in FIG. 8, in the transmitting terminal 100, the PING packet reception processing section 106 first receives an ICMP packet through the packet transmission/reception processing section 107. When receiving the ICMP packet (operation S201, Yes), the PING packet reception processing section 106 passes the received ICMP packet to the PING event acceptance processing section 103.

Upon accepting the ICMP packet, the PING event acceptance processing section 103 checks the type and code of the accepted ICMP packet (operation S202). Then, the PING event acceptance processing section 103 determines, based on the type and code, whether or not the accepted ICMP packet is an all-routes verification response packet.

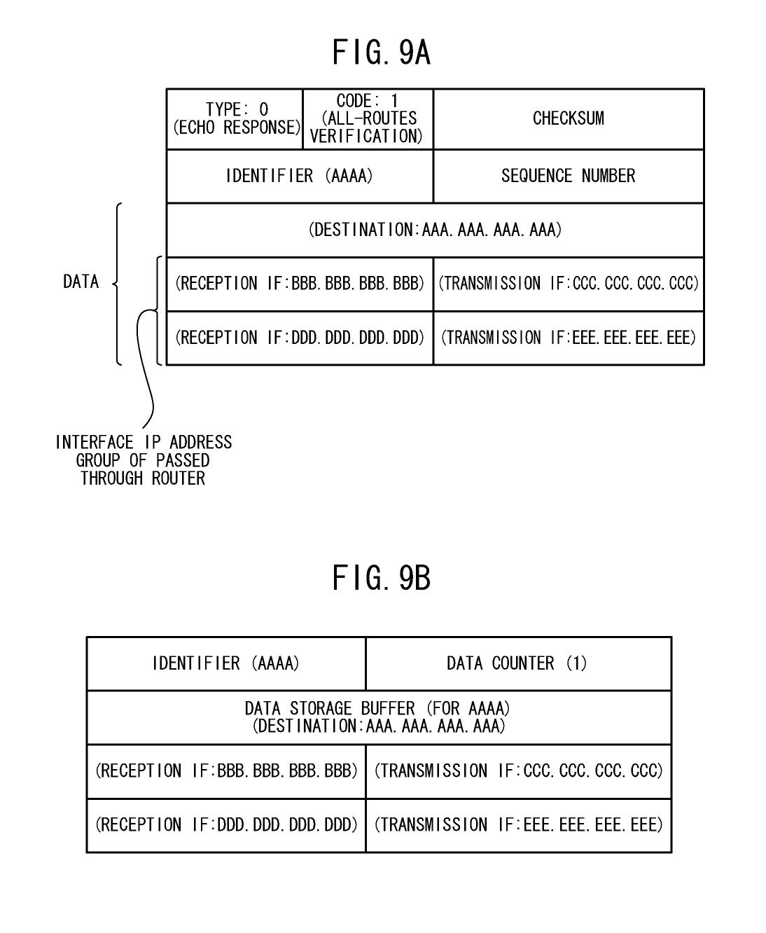

The all-routes verification response packet received by the transmitting terminal 100 will now be described. FIG. 9A is a diagram showing an example of the all-routes verification response packet received by the transmitting terminal 100. FIG. 9B shows the layout of a typical ICMP packet. As shown in FIG. 9A, setting values of the “type”, “code”, “checksum”, “identifier”, “sequence number” and “data” are included in the ICMP packet.

For an all-routes verification response packet, the type is set to “0”. Further, the code is set to “1”. The identifier is set to identification information for associating the all-routes verification request packet with the all-routes verification response packet generated by the same Ping command. For example, the identifier is set to “aaaa”. The sequence number is set to a number that indicates for each identifier how many packets have been transmitted.

The data is set to various information. For an all-routes verification response packet, the contents of the data in the all-routes verification request packet is transcribed into the data, when the packet is generated. In other words, the data in the all-routes verification response packet is set with data to which the addresses of reception interfaces and transmission interfaces of routers through which the all-routes verification request packet has passed are sequentially added as route information. The generation of the all-routes verification response packet will be described in detail later.

Returning to FIG. 8, as a result of the check of the type and code, if the type≠“0” or the code≠“1” (operation S203, No), the PING event acceptance processing section 103 performs reception processing of the ICMP packet for single route specification (operation S204), and finishes the processing. Since the reception processing of the ICMP packet for single route specification is well known, the description thereof is omitted herein.

On the other hand, as a result of the check of the type and code, if the type=“0” and the code=“1” (operation S203, Yes), the PING event acceptance processing section 103 determines that the accepted ICMP packet is an all-routes verification response packet.

Then, if the ICMP packet is determined to be an all-routes verification response packet, the PING event acceptance processing section 103 passes the identifier and data set in the packet to the PING event display processing section 102. Upon accepting the identifier and data, the PING event display processing section 102 refers to the all-routes response buffer storage section 111 to check whether or not a buffer area corresponding to the identifier has been reserved (operation S205).

Then, if no corresponding buffer area has been reserved (operation S206, No), the PING event display processing section 102 finishes the processing. On the other hand, if a buffer area has been reserved (operation S206, Yes), the PING event display processing section 102 stores in the reserved buffer area, the data accepted from the PING event acceptance processing section 103 (operation S207). Further, the PING event display processing section 102 adds “1” to the data counter of the buffer area (operation S208).

As will be described in detail later, a plurality of all-routes verification response packets are forwarded for one all-routes verification request packet. Therefore, each time an all-routes verification response packet is forwarded, the PING event display processing section 102 sequentially stores the data included in the all-routes verification response packet in the same buffer area, and adds “1” to the data counter.

Storage of information in the buffer area reserved in the all-routes response buffer storage section 111 will now be described. FIG. 9B is a diagram showing an example of storage of information in the buffer area reserved in the all-routes response buffer storage section 111. As shown in FIG. 9B, in the all-routes response buffer storage section 111, the addresses of all the reception interfaces and the transmission interfaces set as route information in the data in the all-routes verification response packet are stored in a data storage buffer. Here, each address stored in the data storage buffer serves as information indicating a router through which the all-routes verification request packet has passed.

Returning to FIG. 8, after adding “1” to the data counter of the buffer area, the PING event display processing section 102 refers to the PING transmission type definition data stored by the PING transmission type definition data storage section 112. Subsequently, the PING event display processing section 102 compares a maximum response counter set in the PING transmission type definition data with the data counter of the buffer area (operation S209).

Then, if the data counter has not reached the maximum response counter (operation S210, No), the PING event display processing section 102 finishes the processing. On the other hand, if the data counter has reached the maximum response counter (operation S210, Yes), the PING event display processing section 102 displays the data storage buffer in the buffer area on the user interface section 101 (operation S211).

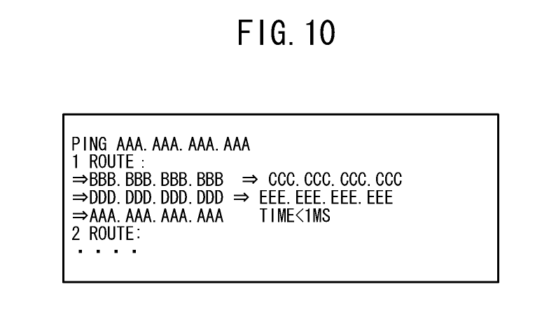

The display of the data storage buffer by the PING event display processing section 102 will now be described. FIG. 10 is a diagram showing an example of the data storage buffer displayed by the PING event display processing section 102. As shown in FIG. 10, for example, following the command shown in FIG. 5A, the PING event display processing section 102 displays the route information set in the data storage buffer, in other words, the addresses of the reception interfaces and the transmission interfaces for each all-routes verification response packet. “1 Route” and “2 Route” shown in FIG. 10 are displayed in order of the all-routes verification response packets.

Returning to FIG. 8, after displaying the data storage buffer on the user interface section 101, the PING event display processing section 102 clears the buffer area including the data storage buffer to be processed, the corresponding identifier and the data counter (operation S212).

After clearing the buffer area, the PING event display processing section 102 passes the identifier corresponding to the cleared buffer area to the PING event acceptance processing section 103. Upon accepting the identifier, the PING event acceptance processing section 103 passes the accepted identifier to the PING event timer processing section 108. Upon accepting the identifier, the PING event timer processing section 108 refers to the timer management data storage section 113 to check whether or not there is timer management data corresponding to the accepted identifier (operation S213).

Then, if there is no corresponding time management data (operation S214, No), the PING event timer processing section 108 finishes the processing. On the other hand, if there is corresponding timer management data (operation S214, Yes), the PING event timer processing section 108 deletes the timer management data in question (operation S215), and finishes the processing.

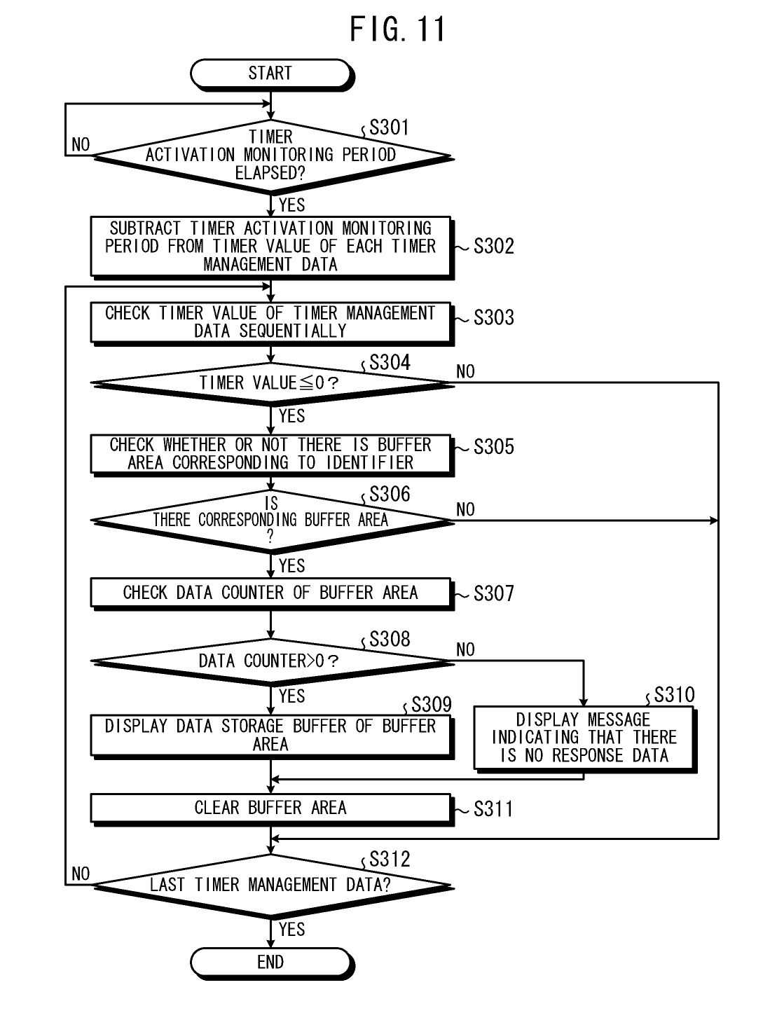

Next, timeout processing in the transmitting terminal 100 after the all-routes verification request packet is transmitted will be described. FIG. 11 is a flowchart showing processing procedure of the timeout processing in the transmitting terminal 100 after the all-routes verification request packet is transmitted.

As shown in FIG. 11, in the transmitting terminal 100, the PING event timer processing section 108 checks by way of a timer whether or not a timer activation monitoring period, which is a predetermined period, has elapsed. Then, if the timer activation monitoring period has elapsed (operation S301, Yes), the PING event timer processing section 108 refers to the timer management data storage section 113. Then, the PING event timer processing section 108 subtracts the timer activation monitoring period from the timer value of each timer management data stored in the timer management data storage section 113 (operation S302).

Subsequently, the PING event timer processing section 108 checks the timer value of the timer management data one by one sequentially (operation S303). Then, if the timer value is “0” or less (operation S304, Yes), the PING event timer processing section 108 passes the identifier set in the timer management data being checked, and a timer expiration notification to the PING event acceptance processing section 103. The PING event acceptance processing section 103, which accepted the identifier and the timer expiration notification, passes the accepted identifier and the timer expiration notification to the PING event display processing section 102. Upon accepting the identifier and the timer expiration notification, the PING event display processing section 102 refers to the all-routes response buffer storage section 111 to check whether or not there is a buffer area corresponding to the accepted identifier (operation S305).

Then, if there is no corresponding buffer area (operation S306, No), the PING event display processing section 102 notifies the PING event timer processing section 108 that there is no buffer area via the PING event acceptance processing section 103.

On the other hand, there is a corresponding buffer area (operation S306, Yes), the PING event display processing section 102 checks the data counter of the buffer area (operation S307). Then, if the data counter of the buffer area is larger than “0” (operation S308, Yes), the PING event display processing section 102 displays the data storage buffer in the buffer area on the user interface section 101 (operation S309). Further, if the data counter of the buffer area is “0” (operation S308, No), the PING event display processing section 102 displays on the user interface section 101 a message indicating that there is no response (operation S310).

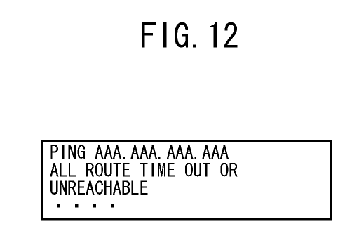

The display of the message indicating that there is no response will now be described. FIG. 12 is a diagram showing an example of a message indicating that there is no response. As shown in FIG. 12, for example, following the command shown in FIG. 5A, the PING event display processing section 102 displays “All route time out unreachable” as the message indicating that there is no response.

Returning to FIG. 11, after displaying the data storage buffer or the message, the PING event display processing section 102 clears the buffer area including the data storage buffer to be processed, the corresponding identifier and the data counter. Then, the PING event display processing section 102 notifies the PING event timer processing section 108 via the PING event acceptance processing section 103 that the buffer area has been cleared (operation S311).

If the timer value of the timer management data is larger than “0” (operation S304, No), the PING event timer processing section 108 checks whether or not the time management data to be processed is the last data. In addition, even when the notification has been accepted in operation S312 and operation S311, the PING event timer processing section 108 similarly checks whether or not the timer management data to be processed is the last data.

Then, if the timer management data to be processed is the last data (operation S312, Yes), the PING event timer processing section 108 finishes the processing. On the other hand, if the timer management data to be processed is not the last data (operation S312, No), the processes of operations S302 to S312 are repeated until all the timer management data are processed.

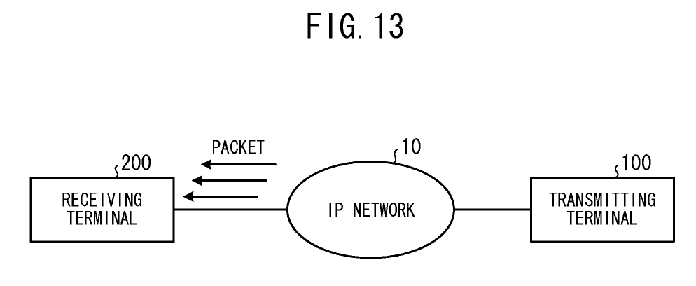

Next, an overview of a receiving terminal 200 will be described. FIG. 13 is a diagram illustrating an overview of the receiving terminal 200. As shown in FIG. 13, the receiving terminal 200 receives the all-routes verification request packet for requesting a connectivity check for all the communication routes between the receiving terminal 200 and the transmitting terminal. Then, when receiving the all-routes verification request packet, the receiving terminal 200 generates an all-routes verification response packet into which the route information included in the received all-routes verification request packet has been transcribed, and transmits it to the IP network 10.

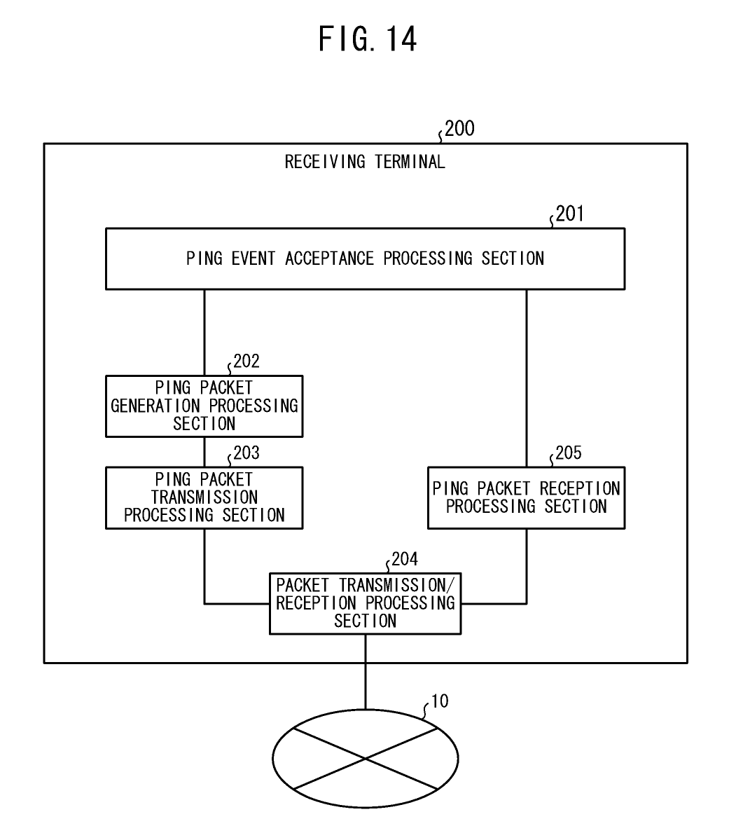

Next, a configuration of the receiving terminal 200 will be described. FIG. 14 is a functional block diagram showing a configuration of the receiving terminal 200. As shown in FIG. 14, the receiving terminal 200 has a PING event acceptance processing section 201, a PING packet generation processing section 202, a PING packet transmission processing section 203, a packet transmission/reception processing section 204 and a PING packet reception processing section 205.

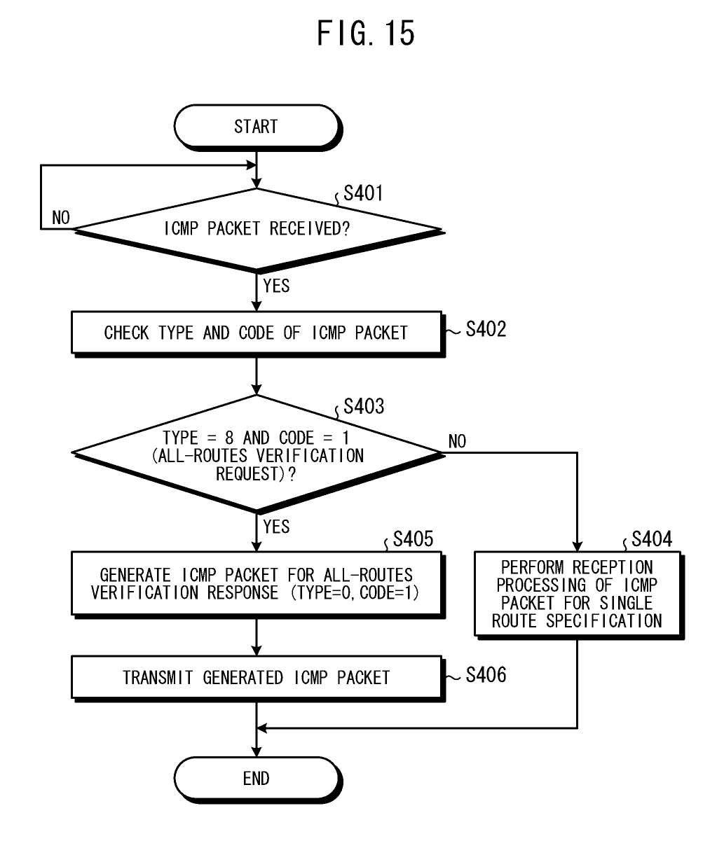

Next, the function of each section owned by the receiving terminal 200 shown in FIG. 14 will be described. The function of each section in processing in the receiving terminal 200 will now be described, from the reception of the all-routes verification request packet to the transmission of the all-routes verification response packet shown in FIG. 13. FIG. 15 is a flowchart showing processing procedure in the receiving terminal 200 from the reception of the all-routes verification request packet to the transmission of the all-routes verification response packet.

As shown in FIG. 15, in the receiving terminal 200, the PING packet reception processing section 205 first receives the ICMP packet through the packet transmission/reception processing section 204. When receiving the ICMP packet (operation S401, Yes), the PING packet reception processing section 205 passes the received ICMP packet to the PING event acceptance processing section 201. Upon accepting the ICMP packet, the PING event acceptance processing section 201 checks the type and code of the accepted ICMP packet (operation S402). Then, the PING event acceptance processing section 201 determines, based on the type and code, whether or not the accepted ICMP packet is an all-routes verification request packet.

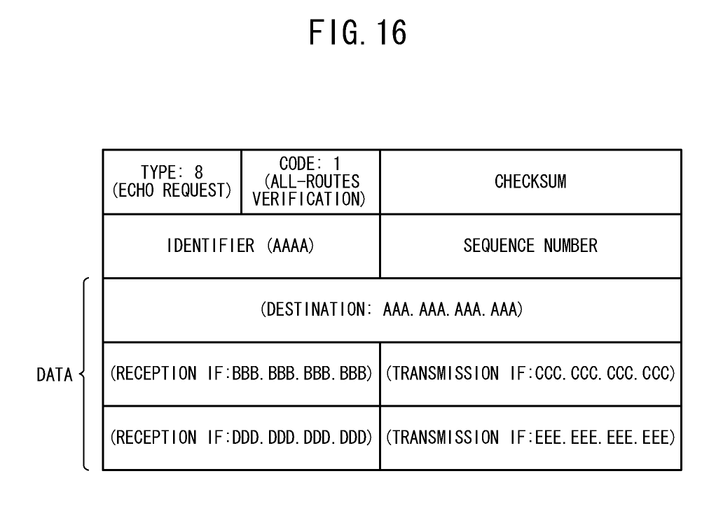

The all-routes verification request packet received by the receiving terminal 200 will now be described. FIG. 16 is a diagram showing an example of the all-routes verification request packet received by the receiving terminal 200. Regarding the setting values other than data, the all-routes verification request packet to be received by the receiving terminal 200 is identical to the all-routes verification request packet shown in FIG. 6A. For example, the type is set to “8” and the code is set to “1”. Then, the addresses of reception interfaces and transmission interfaces of routers through which the packet has passed are sequentially added to the data as route information.

Returning to FIG. 15, as a result of the check of the type and code, if the type≠“8” or the code≠“1” (operation S203, No), the PING event acceptance processing section 201 performs reception processing of the ICMP packet for single route specification (operation S404), and finishes the processing. Since the reception processing of the ICMP packet for single route specification is well known, the description thereof is omitted herein.

On the other hand, as a result of the check of the type and code, if the type=“8” and the code=“1” (operation S403, Yes), the PING event acceptance processing section 201 determines that the accepted ICMP packet is an all-routes verification request packet. Then, if the ICMP packet is determined to be an all-routes verification request packet, the PING event acceptance processing section 201 passes the received all-routes verification request packet to the PING packet generation processing section 202. At the same time, the PING event acceptance processing section 201 requests the PING packet generation processing section 202 to generate an all-routes verification response packet.

When requested to generate the all-routes verification response packet, the PING packet generation processing section 202 generates the all-routes verification response packet based on the all-routes verification request packet accepted from the PING event acceptance processing section 201 (operation S405).

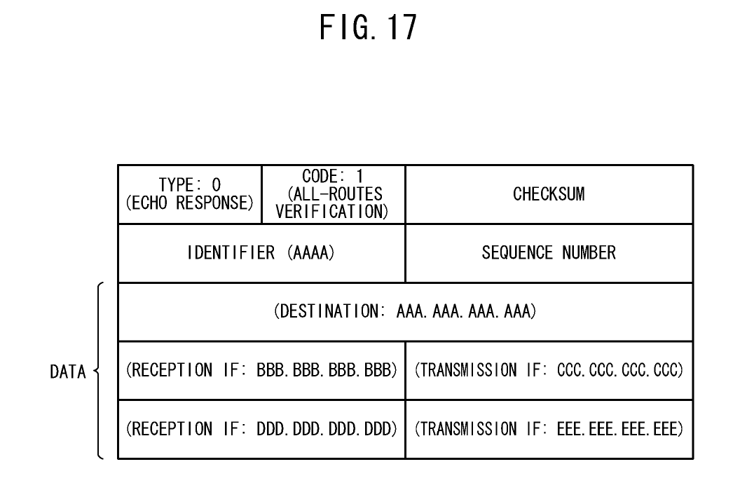

The all-routes verification response packet generated by the PING packet generation processing section 202 of the receiving terminal 200 will now be described. FIG. 17 is a diagram showing an example of the all-routes verification response packet generated by the PING packet generation processing section 202 of the receiving terminal 200. FIG. 17 shows the all-routes verification response packet generated based on the all-routes verification request packet shown in FIG. 16.

Specifically, as shown in FIG. 17, the PING packet generation processing section 202 generates an ICMP packet in which the type is set to “0”, and the code is set to “1” as an all-routes verification response packet. In addition, the PING packet generation processing section 202 transcribes into the identifier and data, the identifier and data that were set in the all-routes verification request packet. Thus, the addresses of the reception interfaces and the transmission interfaces of the routes through which the all-routes verification request packet has passed are transcribed into the all-routes verification response packet.

Returning to FIG. 15, the PING packet generation processing section 202 transmits the generated all-routes verification response packet to the PING packet transmission processing section 203. The PING packet transmission processing section 203 transmits the all-routes verification response packet transmitted from the PING packet generation processing section 202 to the network 10 via the packet transmission/reception processing section 204 (operation S406).

Next, an overview of the routers 300 to 700 will be described. Since the routers 300 to 700 have the same configuration, the router 300 will be described below as an example. When receiving the all-routes verification request packet transmitted from the transmitting terminal 100, the router 300 adds information representing the router itself to the received all-routes verification request packet as route information. Then, the router 300 forwards the all-routes verification request packet to which the route information has been added to each of all the communication routes between the receiving terminal 200 and the router. On the other hand, when receiving the all-routes verification response packet transmitted from the receiving terminal 200, the router 300 forwards the received all-routes verification response packet to the transmitting terminal 100.

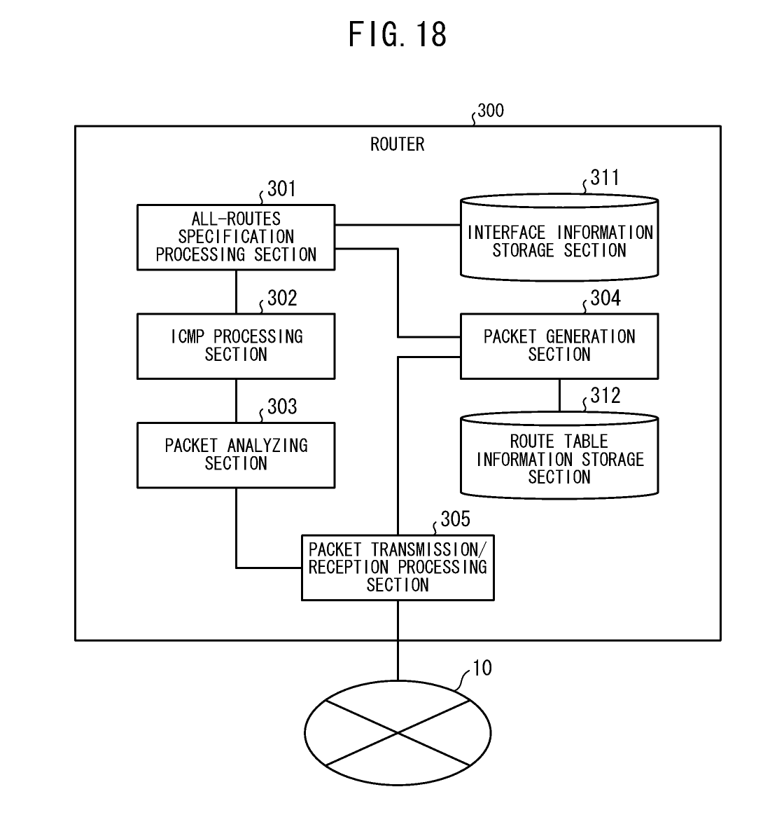

Next, a configuration of the router 300 will be described. FIG. 18 is a functional block diagram showing a configuration of the router 300. As shown in FIG. 18, the router 300 has an all-routes specification processing section 301, an ICMP processing section 302, a packet analyzing section 303, a packet generator 304 and a packet transmission/reception processing section 305. The router 300 also has an interface information storage section 311 and a route table information storage section 312.

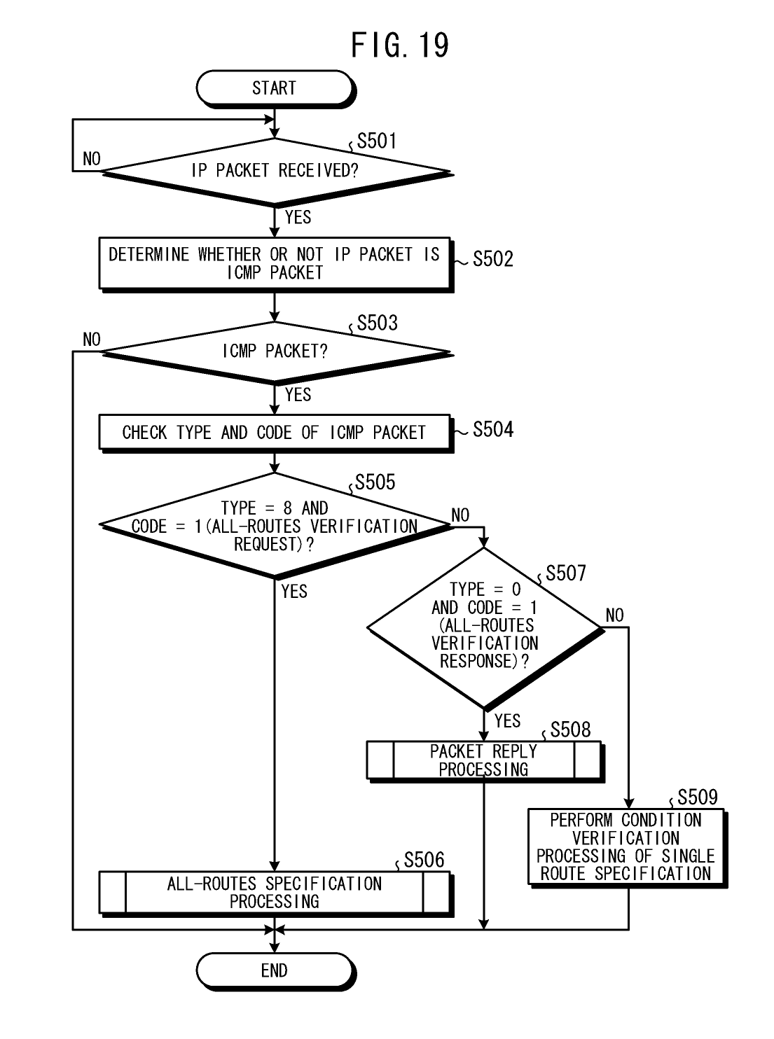

Next, the function of each section owned by the router 300 shown in FIG. 18 will be described. Here, the function of each section in forwarding processing of the all-routes verification request packet or the all-routes verification response packet will be described. FIG. 19 is a flowchart showing processing procedure in the router 300 for forwarding the all-routes verification request packet or the all-routes verification response packet.

As shown in FIG. 19, in the router 300, the packet transmission/reception processing section 305 first receives an IP packet. When receiving the IP packet (operation S501, Yes), the packet transmission/reception processing section 305 activates the packet analyzing section 303. When activated by the packet transmission/reception processing section 305, the packet analyzing section 303 determines whether or not the received IP packet is an ICMP packet (operation S502).

Specifically, when the value of a “protocol” included in the IP header of the received IP packet is “1”, the packet analyzing section 303 determines that the IP packet is an ICMP packet. On the other hand, if the value of the “protocol” is not “1”, the packet analyzing section 303 determines that the IP packet is not an ICMP packet.

Then, if the IP packet is not an ICMP packet (operation S503, No), the packet analyzing section 303 finishes the processing. On the other hand, if the IP packet is an ICMP packet (operation S503, Yes), the packet analyzing section 303 activates the ICMP processing section 302. When activated by the packet analyzing section 303, the ICMP processing section 302 checks the type and code of the received ICMP packet (operation S504).

Then, as a result of the check of the type and code, if the type=“8” and the code=“1”(operation S505, Yes), the ICMP processing section 302 determines that the received ICMP packet is an all-routes verification request packet. If the ICMP packet is determined to be an all-routes verification request packet, the ICMP processing section 302 causes the all-routes specification processing section 301 to perform “all-routes specification processing” (operation S506). The all-routes specification processing will be described in detail later.

On the other hand, if the type=“0” and the code=“1” (operation S505, No, operation S507, Yes), the ICMP processing section 302 determines that the received ICMP packet is an all-routes verification response packet. The ICMP processing section 302 causes the all-routes specification processing section 301 to perform “packet reply processing” (operation S508). The packet reply processing will be described in detail later.

If any case from the type≠“8”, the type≠“0”, or the code≠“1” (operation S507, No), the ICMP processing section 302 performs forwarding processing of the ICMP packet for single route specification (operation S509), and finishes the processing. Since the forwarding processing of the ICMP packet for single route specification is well known, the description thereof is omitted herein.

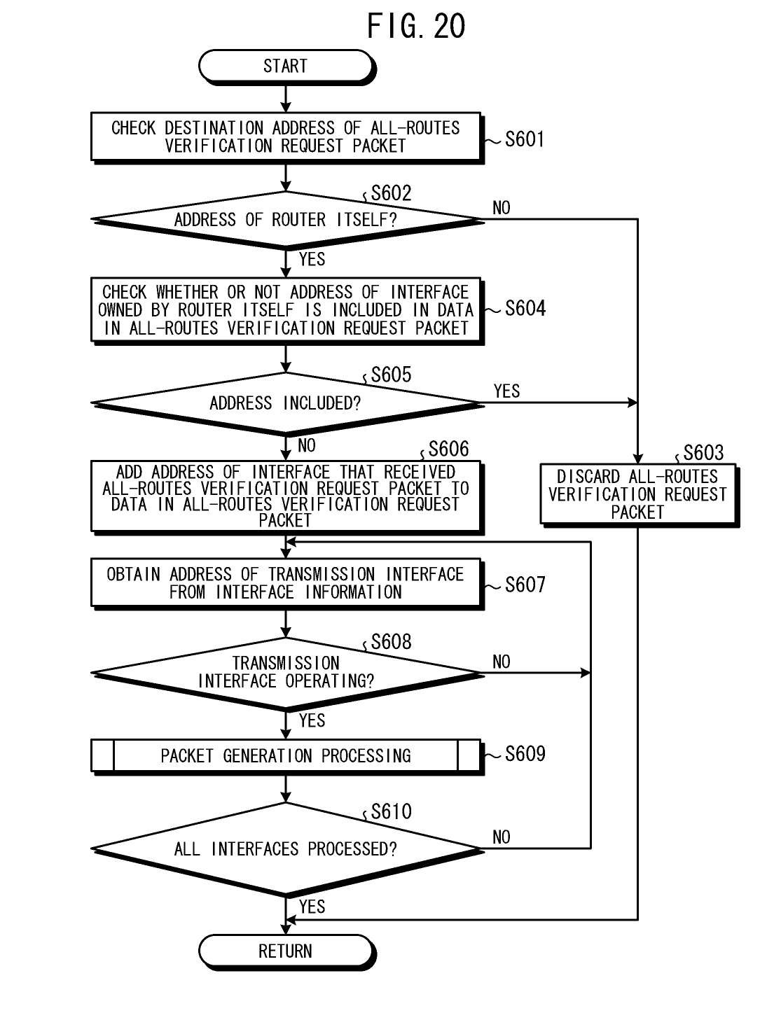

Next, the processing procedure of the all-routes specification processing shown in FIG. 19 will be described. FIG. 20 is a flowchart showing processing procedure of all-routes specification processing shown in FIG. 19. As shown in FIG. 20, in all-routes specification processing, the all-routes specification processing section 301 first checks the destination address of the received all-routes verification request packet (operation S601).

If the destination address is not the address of the router itself (operation S602, No), the all-routes specification processing section 301 discards the all-routes verification request packet being processed (operation S603). On the other hand, if the destination address is the address of the router itself (operation S602, Yes), the all-routes specification processing section 301 checks whether or not the address of the interface owned by the router itself is included in the data in the all-routes verification request packet (operation S604).

Then, if the address of the interface owned by the router itself is included (operation S605, Yes), the all-routes specification processing section 301 discards the all-routes verification request packet being processed (operation S603). On the other hand, if the address of the interface owned by the router itself is not included (operation S605, No), the all-routes specification processing section 301 adds the address of the interface that received the all-routes verification request packet to the data in the all-routes verification request packet (operation S606).

When adding the address of the interface to the data in the all-routes verification request packet, the all-routes specification processing section 301 compares the pointer and the packet length respectively included in the all-routes verification request packet. Then, only when the value of the pointer is smaller than the packet length, the all-routes specification processing section 301 adds the address of the interface at the position indicated by the pointer and updates the pointer.

Subsequently, the all-routes specification processing section 301 refers to the interface information stored in the interface information storage section 311. Here, the interface information means information including the addresses of all the interfaces owned by the router 300. Then, the all-routes specification processing section 301 obtains any one address from among the addresses included in the interface information, as the address of a transmission interface (operation S607).

Subsequently, the all-routes specification processing section 301 checks whether or not the obtained transmission interface is being operated. Here, if the transmission interface is not being operated (operation S608, No), the all-routes specification processing section 301 returns to operation S607 to obtain the address of another interface, as the address of a transmission interface.

On the other hand, if the transmission interface is being operated (operation S608, Yes), the all-routes specification processing section 301 passes the address of the transmission interface to the packet generator 304. At the same time, the all-routes specification processing section 301 causes the packet generator 304 to perform “packet generation processing” (operation S609). The packet generation processing will be described in detail later.

When the packet generation processing is finished, the all-routes specification processing section 301 checks whether or not the above-described processing has been performed on all the interfaces included in the interface information stored in the interface information storage section 311. Then, if the processing has been performed on all the interfaces (operation S610, Yes), the all-routes specification processing is finished. On the other hand, if there is any other interface on which the processing has not been performed yet (operation S610, No), the processes of operations S607 to S610 are repeated until all the interfaces are processed.

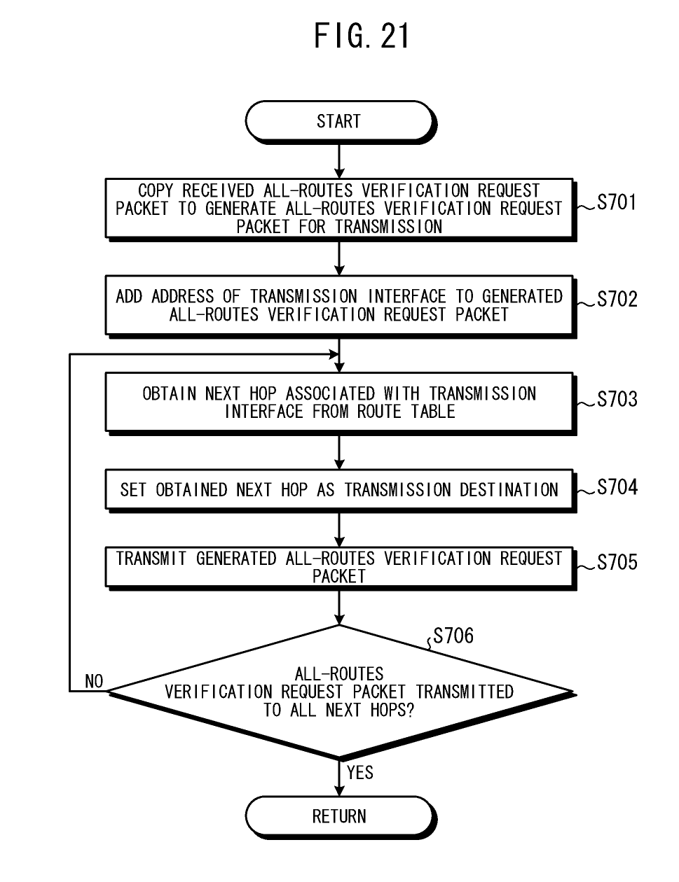

Next, the processing procedure of the packet generation processing shown in FIG. 20 will be described. FIG. 21 is a flowchart showing processing procedure of packet generation processing shown in FIG. 20. As shown in FIG. 21, in the packet generation processing, the packet generator 304 first copies the received all-routes verification request packet to generate an all-routes verification request packet for transmission (operation S701).

Then, the packet generator 304 adds the address of the transmission interface passed from the all-routes specification processing section 301 at the position indicated by the pointer included in the generated all-routes verification request packet (operation S702). Subsequently, the packet generator 304 refers to the route table information stored in the route table information storage section 312. Here, the route table information means information associating an interface owned by the router 300 with the next hop. The “next hop” described herein is set to the address of an adjacent router.

Subsequently, the packet generator 304 obtains from among next hops included in the route table information, a next hop associated with the transmission interface passed from the all-routes specification processing section 301 (operation S703). Then, the packet generator 304 sets the obtained next hop as the transmission destination (operation S704), and transmits the all-routes verification request packet via the packet transmission/reception processing section 305 (operation S705).

Subsequently, the packet generator 304 checks whether or not the all-routes verification request packet has been transmitted to all the next hops associated with the transmission interface passed from the all-routes specification processing section 301 among the next hops included in the route table information. Then, if the all-routes verification request packet has been transmitted to all the next hops (operation S706, Yes), the packet generation processing is generated. On the other hand, if there is any other next hop to which the all-routes verification request has not been transmitted yet (operation S706, No), the processes of operations S703 to S706 are repeated until all the next hops are processed associated with the transmission interface.

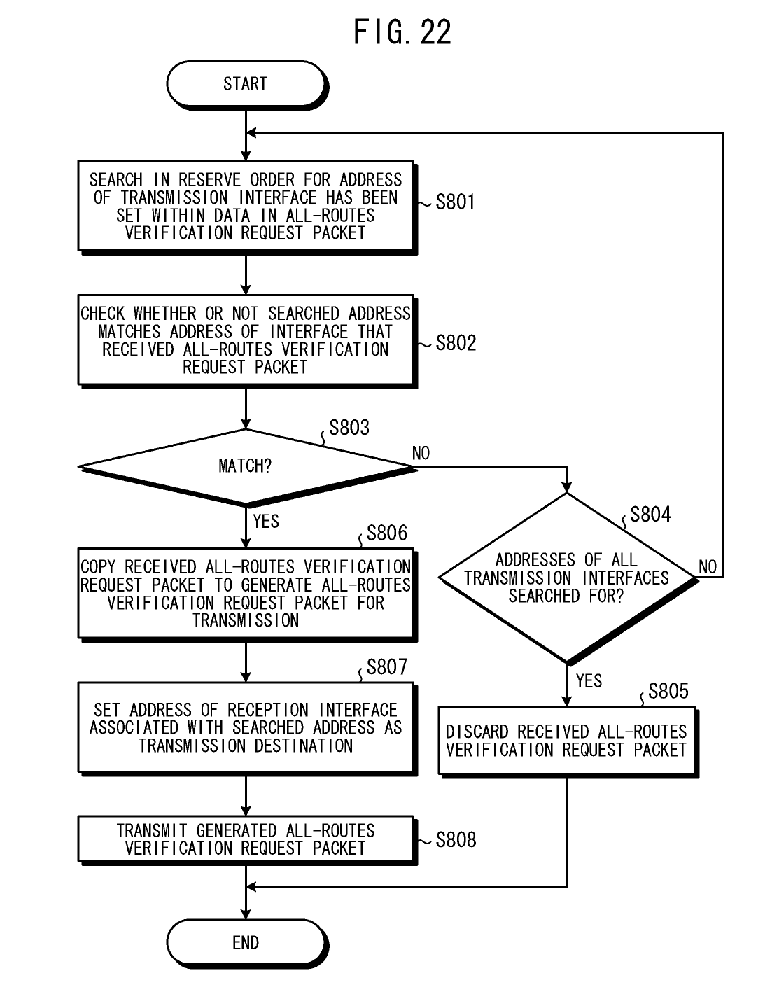

Next, the processing procedure of the packet reply processing shown in FIG. 19 will be described. FIG. 22 is a flowchart showing processing procedure of packet reply processing shown in FIG. 19. As shown in FIG. 22, in the packet reply processing, the all-routes specification processing section 301 first searches in reverse order for one address of the transmission interface that has been set within the data in the received all-routes verification response packet (operation S801).

Then, the all-routes specification processing section 301 checks whether or not the searched address matches the address of the interface that received the all-routes verification response packet (operation S802). Subsequently, if the addresses do not match (operation S803, No), the all-routes specification processing section 301 determines whether or not the addresses of all the transmission interfaces have been searched within the data in the all-routes verification response packet.

Here, if there is any other address of a transmission interface that has not been searched yet (operation S804, No), the all-routes specification processing section 301 returns to operation S801 to search for the next address. On the other hand, if addresses of all the transmission interfaces have been searched (operation S804, Yes), the all-routes specification processing section 301 discards the all-routes verification response packet being processed (operation S805), and finishes the packet reply processing. In addition, if the searched address matches the address of the interface that received the all-routes verification response packet (operation S803, Yes), the all-routes specification processing section 301 copies the received all-routes verification response packet to generate an all-routes verification response packet for transmission (operation S806).

Subsequently, the all-routes specification processing section 301 obtains the address of the reception interface associated with the address of the transmission interface searched within the data in the all-routes verification response packet. Then, the all-routes specification processing section 301 sets the obtained address as the transmission destination (operation S807), and transmits the all-routes verification response packet via the packet transmission/reception processing section 305 (operation S808).

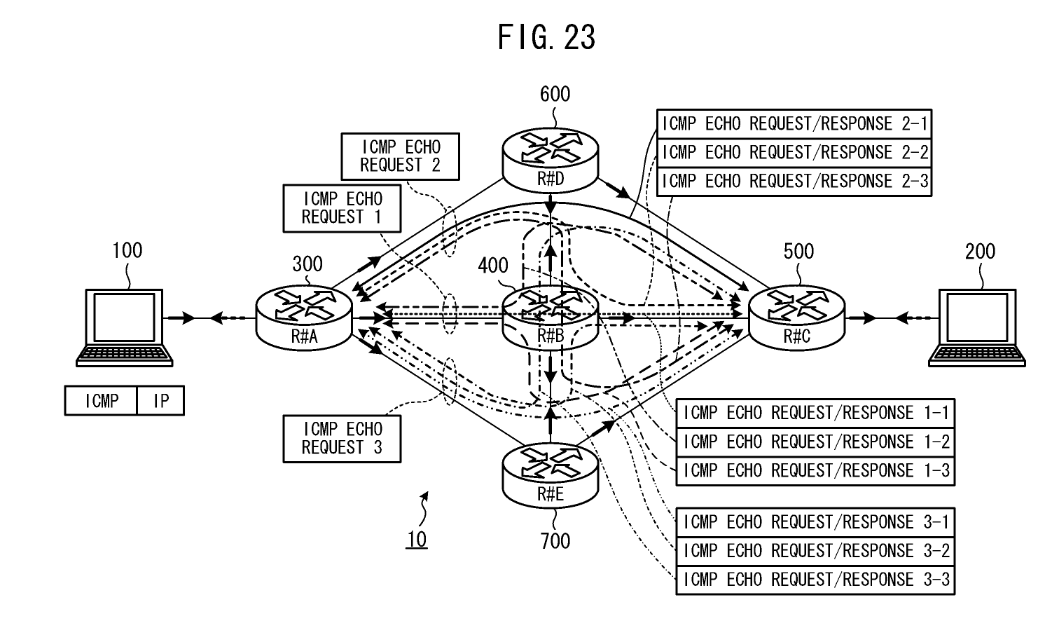

Next, the flow of the packet forwarding according to the embodiment will be described. FIG. 23 is a diagram illustrating a first example of packet forwarding according to the embodiment. As shown in FIG. 23, in the network system according to the embodiment, when a connectivity check is performed between the transmitting terminal 100 and the receiving terminal 200, an ICMP packet for all-routes specification is propagated through nine communication routes in total: ICMP echo requests/responses 1-1 to 1-3, 2-1 to 2-3, and 3-1 to 3-3.

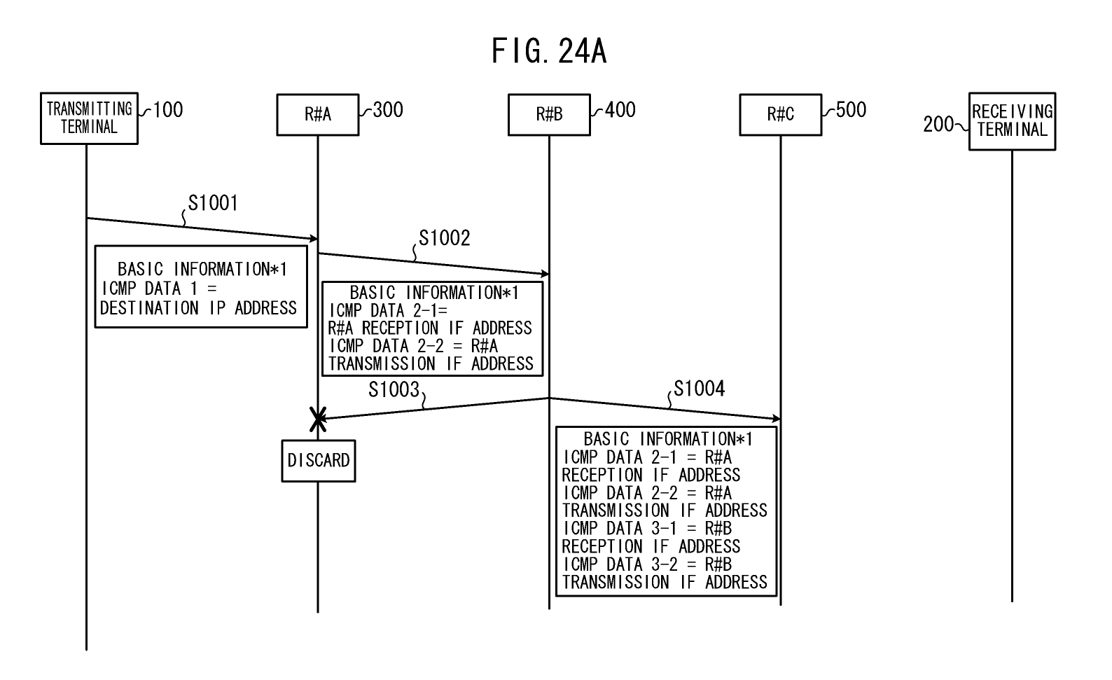

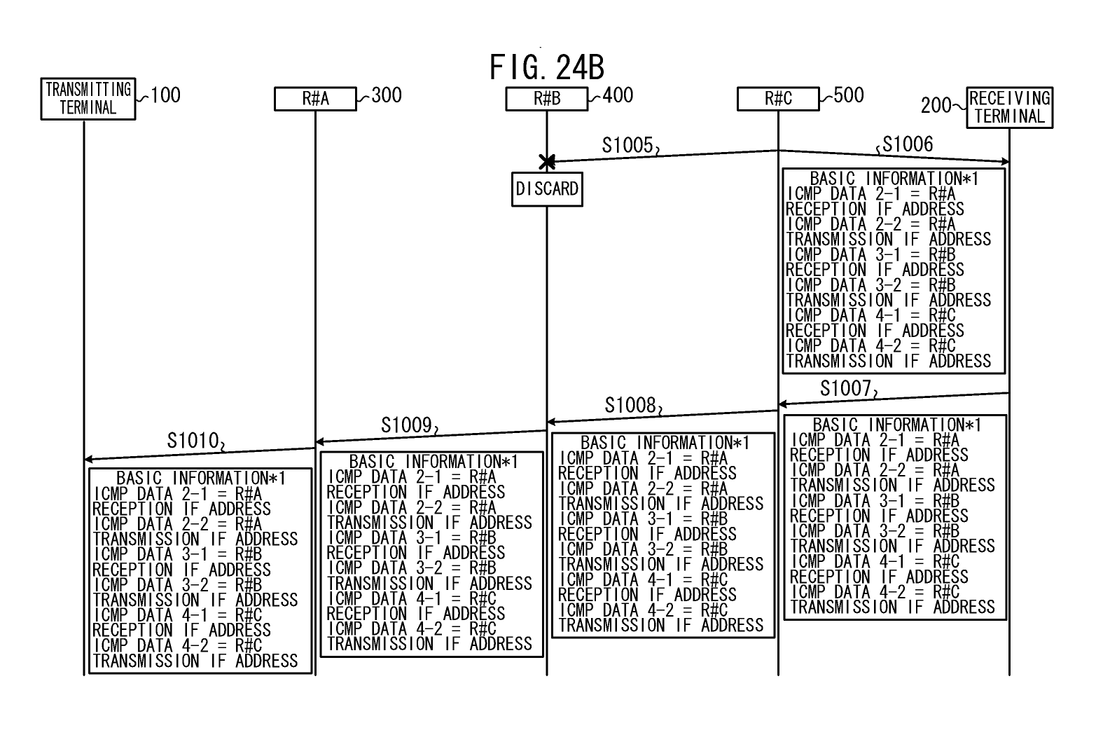

The flow of the ICMP packet forwarded through the communication route of the ICMP echo request/response 1-1 shown in FIG. 23 will now be described as an example. FIGS. 24A and 24B are sequence diagrams showing the first example of packet forwarding according to the embodiment. In FIGS. 24A and 24B, the ICMP packet forwarded in operations S1001 to S1006 is an “all-routes verification request packet”. Further, the ICMP packet forwarded in operations S1007 to S1010 is an “all-routes verification response packet”. The all-routes verification request packet is referred to as a “request packet”, and the all-routes verification response packet is referred to as a “response packet” herein.

As shown in FIGS. 24A and 24B, the transmitting terminal 100 first transmits a request packet including basic information and a destination IP address (operation S1001). Here, the basic information means a type, a code, a checksum, an identifier and a sequence number. Subsequently, the router 300 adds the address of the interface owned by the router itself to the request packet received from the transmitting terminal 100. Then, the router 300 forwards the request packet to the router 400 based on the route table information (operation S1002).

Subsequently, the router 400 adds the address of the interface owned by the router itself to the request packet received from the router 300. Then, the router 400 transmits the request packet to each of the routers 300 and 500 based on the route table information (operations S1003 and S1004). Here, the router 300 discards the received request packet since the address of the interface owned by the router itself is included in the request packet received from the router 400.

On the other hand, the router 500 adds the address of the interface owned by the router itself to the request packet received from the router 400. Then, the router 500 transmits the request packet to each of the router 400 and the receiving terminal 200 based on the route table information (operations S1005 and S1006). Here, similarly to the router 300, the router 400 discards the request packet received from the router 500.

On the other hand, the receiving terminal 200 generates a response packet into which the route information included in the request packet received from the router 500 has been transcribed. Then, the receiving terminal 200 transmits the generated response packet to the router 500 (operation S1007). Here, the routers 500, 400 and 300 follow backward the address information included in the response packet, forwarding sequentially the response packets transmitted from the receiving terminal 200, to forward the response packets to the transmitting terminal 100 (operation S1008 to S1010).

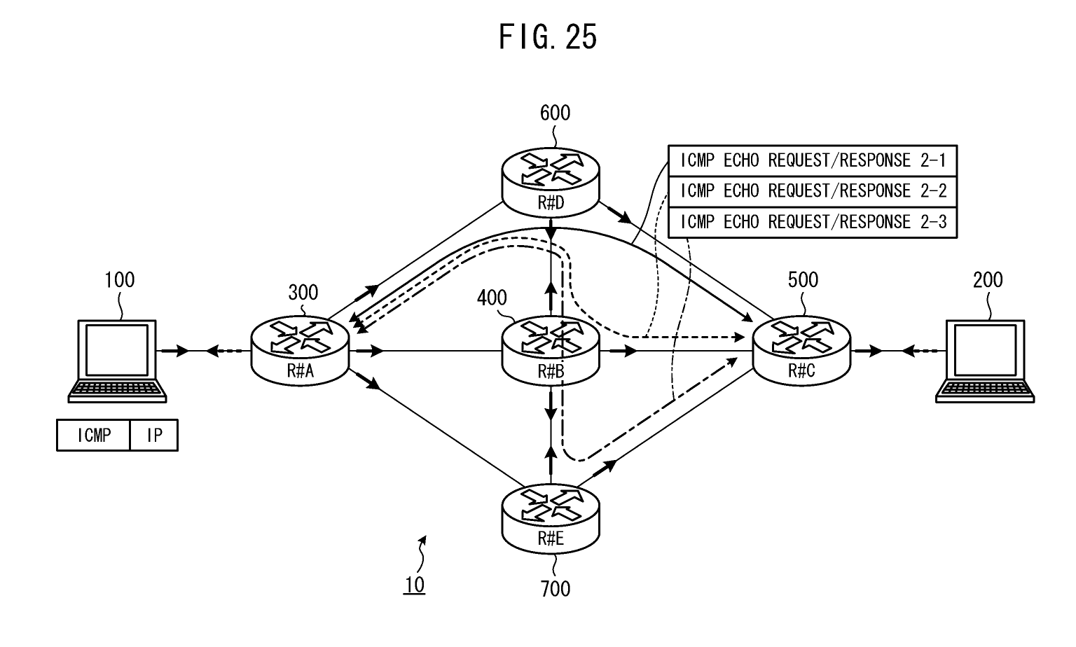

Next, another example of packet forwarding according to the embodiment will be described. FIG. 25 is a diagram illustrating a second example of packet forwarding according to the embodiment. FIG. 25 shows the communication routes of the ICMP echo requests/responses 2-1 to 2-3 among the communication routes shown in FIG. 23. After passing through the routers 300 and 600, the communication route shown in FIG. 25 branches to a route to the router 500, a route to the router 500 via the router 400, and a route to the router 500 via the routers 400 and 700.

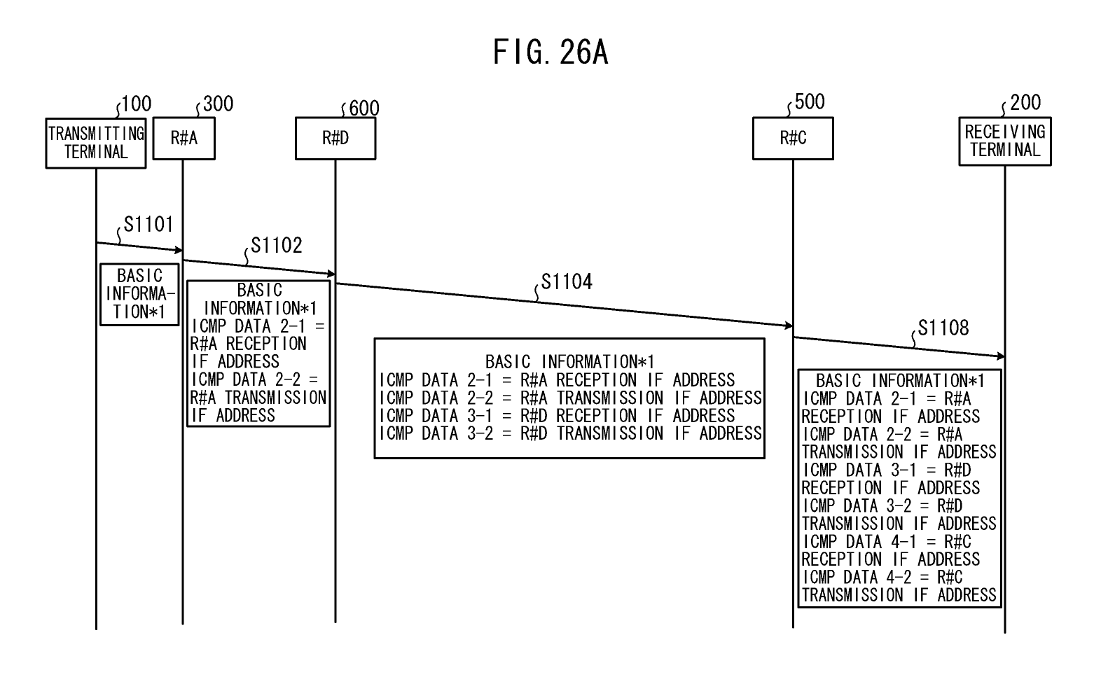

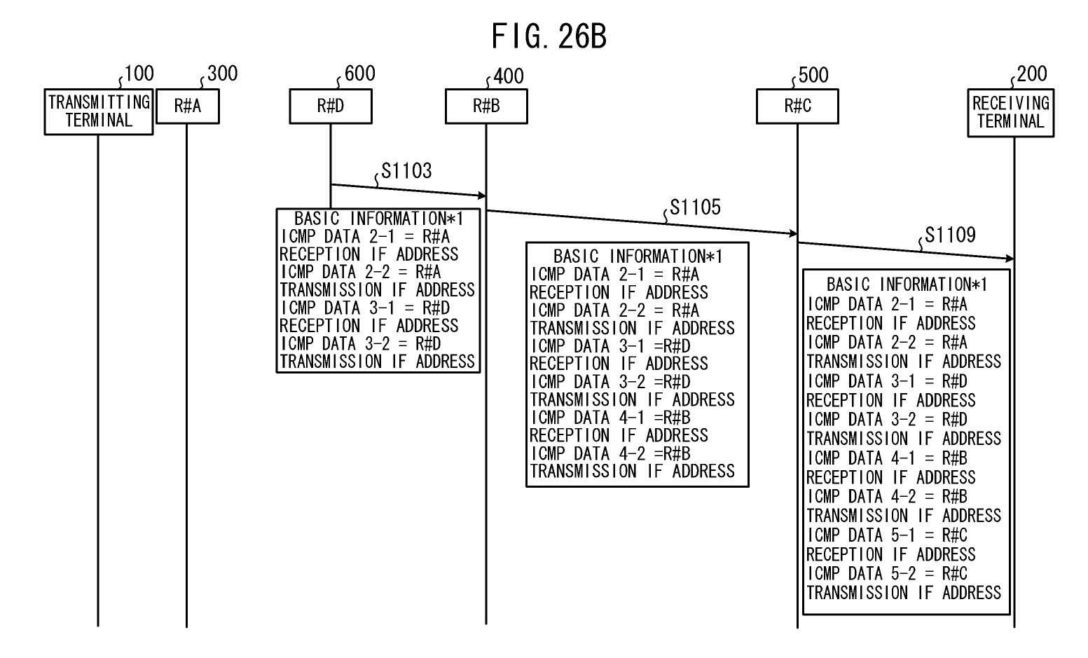

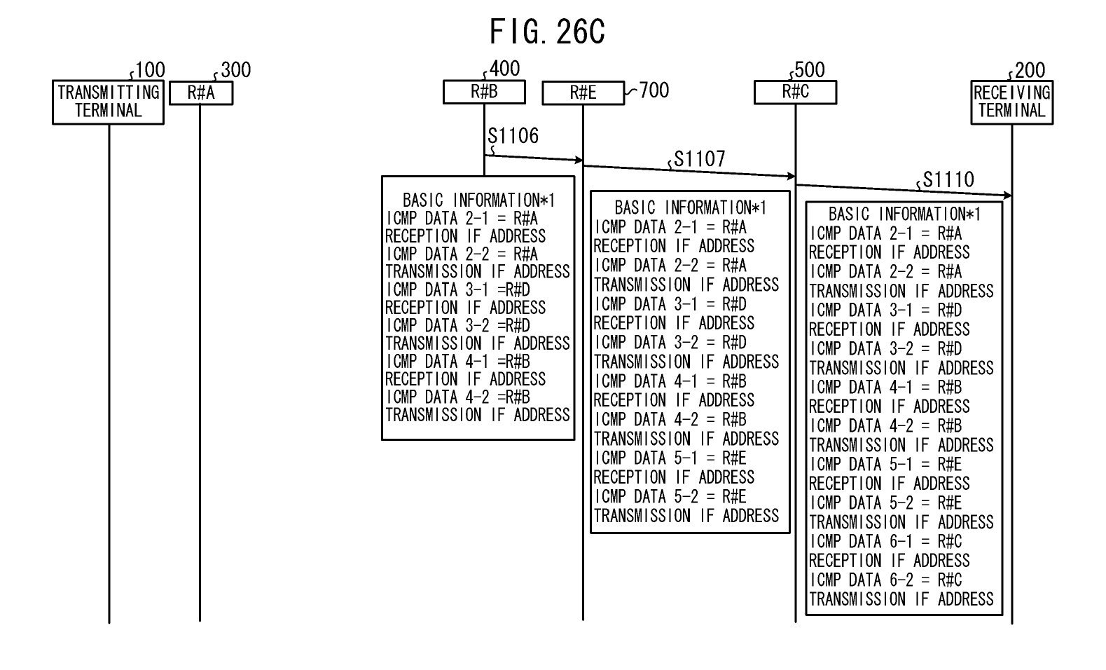

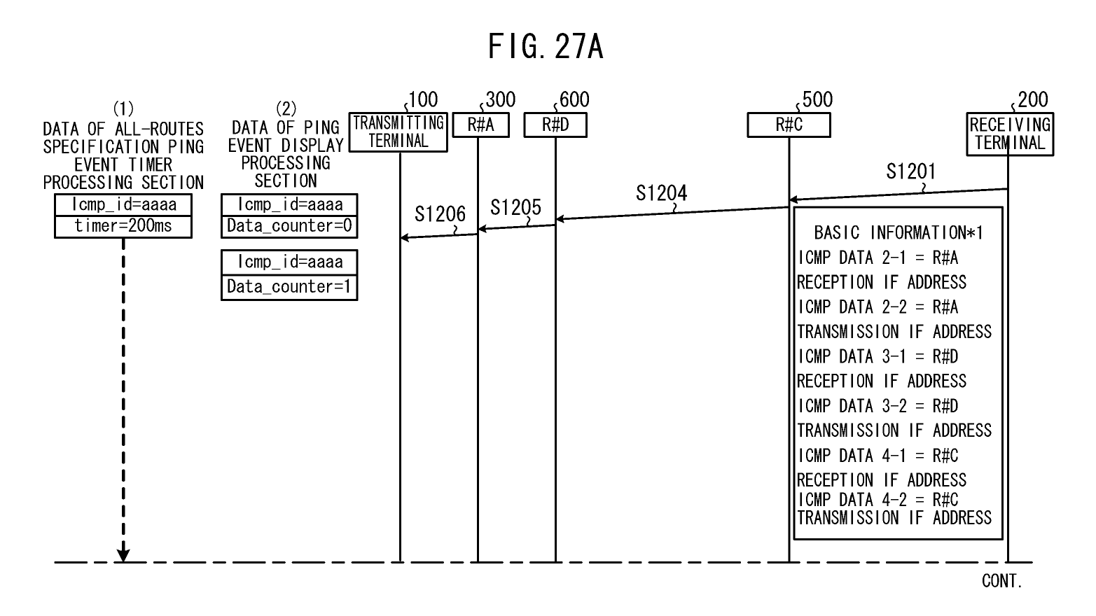

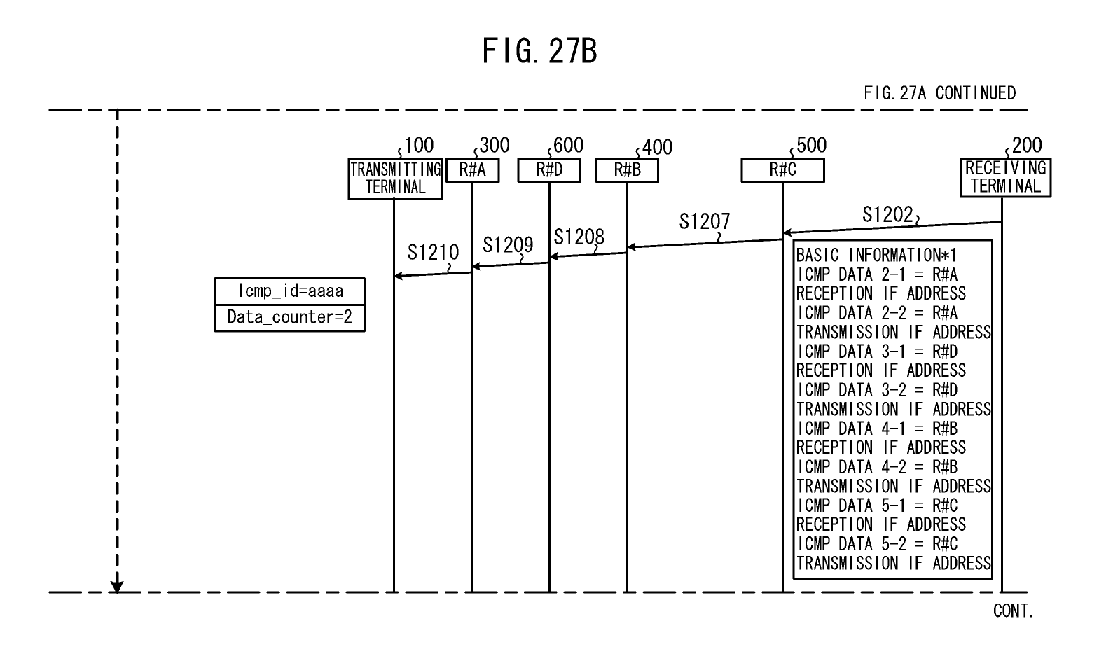

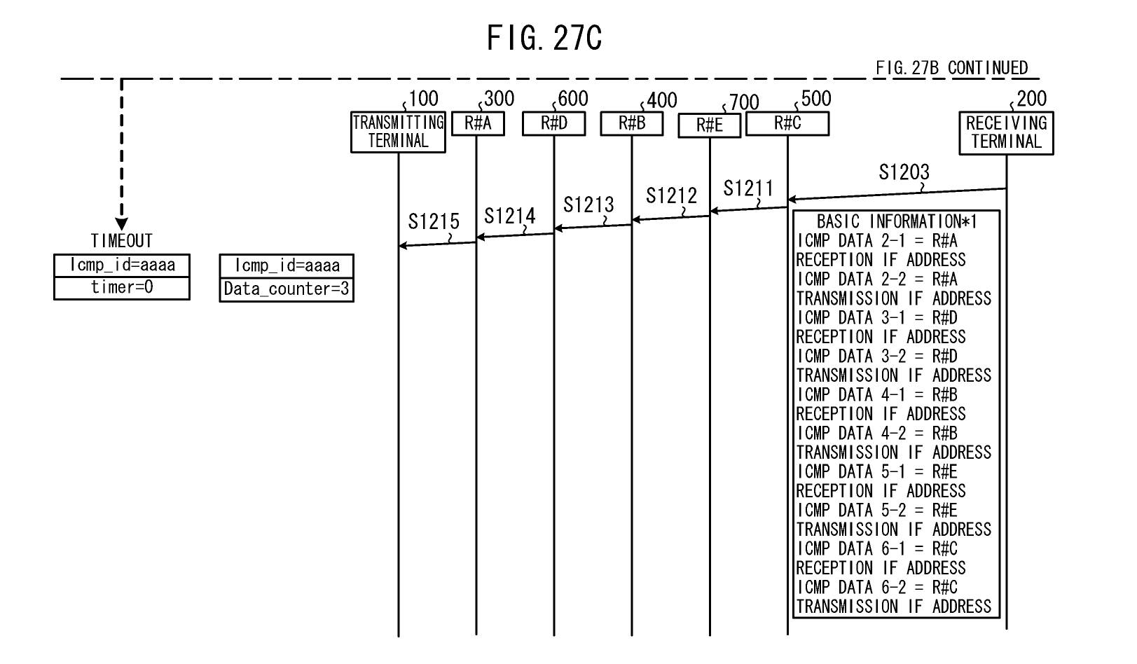

The flow of the ICMP packet forwarded through the communication routes of the ICMP echo requests/responses 2-1 to 2-3 shown in FIG. 25 will now be described. FIGS. 26 and 27 are sequence diagrams showing a second example of packet forwarding according to the embodiment. In FIGS. 26A to 26C, the ICMP packet forwarded in operations S1101 to S1110 is an “all-routes verification request packet”. In FIGS. 27A to 27C, the ICMP packet forwarded in operations S1201 to S1215 is an “all-routes verification response packet”. The all-routes verification request packet is referred to as a “request packet”, and the all-routes verification response packet is referred to as a “response packet” herein.

As shown in FIGS. 26A to 26C, the transmitting terminal 100 first transmits a request packet including basic information and a destination IP address (operation S1101). Here, the basic information means a type, a code, a checksum, an identifier and a sequence number. Subsequently, the router 300 adds the address of the interface owned by the router itself to the request packet received from the transmitting terminal 100. Then, the router 300 forwards the request packet to the router 600 based on the route table information (operation S1102).

Subsequently, the router 600 adds the address of the interface owned by the router itself to the request packet received from the router 300. Then, the router 600 transmits the request packet to each of the routers 400 and 500 based on the route table information (operations S1103 and S1104). Subsequently, the router 400 adds the address of the interface owned by the router itself to the request packet received from the router 300. Then, the router 400 transmits the request packet to each of the routers 500 and 700 based on the route table information (operations S1105 and S1106).

Subsequently, the router 700 adds the address of the interface owned by the router itself to the request packet received from the router 300. Then, the router 700 transmits the request packet to the router 500 based on the route table information (operation S1107). Then, the router 500 adds the address of the interface owned by the router itself to the request packet received from the routers 600, 400 and 700, and transmits the request packets to which the addresses have been added to the receiving terminal 200 (operations S1108 to S1110).

Through the series of flows described above, each request packet passing through each communication route shown in FIG. 25 is transmitted to the receiving terminal 200.

Then, as shown in FIGS. 27A to 27C, the receiving terminal 200 generates a plurality of response packets into which the route information included in each of the received request packets has been transcribed, and transmits each of the generated response packets to the router 500 (operations S1201 to S1203). Subsequently, the routers 500, 600 and 300 follow backward the address information included in the response packet, forwarding each of the response packets transmitted from the receiving terminal 200, to forward each response packet to the transmitting terminal 100 (operations S1204 to S1206, operations S1207 to S1210, and operations S1211 to S1215).

FIGS. 27A to 27C (1) show the state of the timer management data controlled by the PING event timer processing section 108 of the transmitting terminal 100. For example, if the initial value of the timer was 200 ms, if not even one response packet has been forwarded to the transmitting terminal 100 even after 200 ms has elapsed, the time is out at the point of time when the timer has reached 0, as shown in FIGS. 27A to 27C (1).

In addition, FIGS. 27A to 27C (2) show the state of the data storage buffer displayed on the user interface section 101 by the PING event display processing section 102 of the transmitting terminal 100. As shown in FIGS. 27A to 27C (2), for example, the data counter (Data_counter) representing each communication route is displayed on the user interface section 101 for each communication route through which the response packet has been forwarded to the transmitting terminal 100.

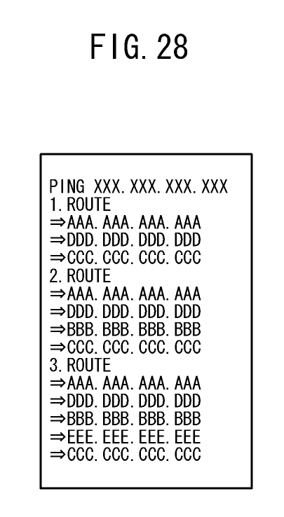

FIG. 28 is a diagram showing an example of the route information displayed based on the ICMP packet shown in FIGS. 26A to 26C and 27A to 27C. If the data in three response packets shown in FIGS. 26A to 26C and 27A to 27C are forwarded to the transmitting terminal 100, the PING event display processing section 102 displays for each communication route, the information on the routers on three communication routes, for example, as shown in FIG. 28. For example, in FIG. 28, “AAA.AAA.AAA.AAA” represents the reception address or transmission address of the router 300, and “DDD.DDD.DDD.DDD” represents the reception address or transmission address of the router 600. In addition, “CCC.CCC.CCC.CCC” represents the reception address or transmission address of the router 500, and “BBB.BBB.BBB.BBB” represents the reception address or transmission address of the router 400. Further, “EEE.EEE.EEE.EEE” represents the reception address or transmission address of the router 700.

In addition, “1. Route” shown in FIG. 28 represents the route of the ICMP echo request/response 2-1 shown in FIG. 25. Further, “2. Route” represents the route of the ICMP echo request/response 2-2, and “3. Route” represents the route of the ICMP echo request/response 2-3. The PING event display processing section 102 displays the information representing each route on the user interface section 101 based on the data counter shown in FIGS. 27A to 27C (2), for example.

As described above, in the embodiment, the transmitting terminal 100 generates the all-routes verification request packet for requesting a connectivity check for all communication routes between the receiving terminal 200 and the transmitting terminal 100, and transmits the generated all-routes verification request packet to the routers 300 to 700. Further, when receiving the all-routes verification request packet transmitted by the transmitting terminal 100, the routers 300 to 700 add information representing each router itself to the received all-routes verification request packet as route information.

In addition, the routers 300 to 700 forward the all-routes verification request packet to which the route information has been added to each of all the communication routes between the receiving terminal 200 and the routers. Moreover, when receiving the all-routes verification request packet forwarded by each of the routers 300 to 700, the receiving terminal 200 generates an all-routes verification response packet into which the route information included in the received all-routes request packet has been transcribed.

Furthermore, the receiving terminal 200 transmits the generated all-routes verification response packet to the transmitting terminal 100 via the routers 300 to 700. In addition, when receiving the all-routes verification response packet transmitted by the receiving terminal 200, the routers 300 to 700 forward the received response packets to the transmitting terminal 100. Then, when receiving the all-routes verification response packets forwarded by the routers 300 to 700, the transmission terminal 100 outputs the route information included in the received all-routes response packets. Consequently, according to the embodiment, a connectivity status can be verified not only for a communication route being operated but also for an auxiliary communication route.

In addition, according to the embodiment, when forwarding the all-routes verification response packet, based on the route information included in the all-routes verification response packets, the routers 300 to 700 follow backward the routes through which the all-routes verification request packet has been forwarded, which is the basis for the all-routes verification response packet, to forward the all-routes verification response packet. Therefore, according to the embodiment, since no identical all-routes verification response packets are forwarded through a plurality of communication routes, the congestion of a communication route can be prevented.

In addition, according to the embodiment, if information representing each router itself has already been included in the all-routes verification request packet before the routers 300 to 700 add route information to the all-routes verification request packet, the all-routes verification request packet in question is discarded. Consequently, according to the embodiment, since the number of packets forwarded through the communication route can be reduced, the load on the communication route can be reduced.

Further, according to the embodiment, the transmitting terminal 100 measures the elapsed time since the all-routes verification request packet has been transmitted. Then, if the measured elapsed time exceeds a predetermined time, the transmitting terminal 100 outputs information representing that there is no response to the all-routes verification request packet. Consequently, according to the embodiment, the occurrence of an anomaly on the communication route can be easily detected.

Furthermore, according to the embodiment, the transmitting terminal counts the number of times an all-routes verification response packet has been received, and if the counted number of times exceeds a predetermined number of times, outputs the route information. Consequently, according to the embodiment, route information can be efficiently output.

For example, in a network having operating/standby routes, or first/second/ . . . /n^{th} routes as a plurality of communication routes, if a monitoring device monitors the communication routes by Ping, only the operating route or the first route is the communication route that can be monitored. Here, the first route means a communication route used with the highest priority among a plurality of communication routes.

As in the foregoing, if the connectivity status of an auxiliary communication route cannot be verified, even if an anomaly had occurred on the standby route, the detection of the anomaly would be delayed. As a result, switching from the operating route to the standby route would be delayed, and an interruption of communication would occur over an extended time on the network. That is, this leads to the result that the backup function owned by the network cannot play its role fully.

Means for establishing communications using a backup route include a policy routing function. However, since the policy routing function requires the policy of routing to be defined for individual network equipment on the communication route, depending on the scale of the network, there are problems that the setting requires tremendous work, the communication is disabled because of setting error, and the like.

In addition, if a route is specified by Ping with an option in a disk operating system (DOS) command, there is a problem that the number of routes or the number of hosts specified being limited, a large scale network cannot be handled.

In contrast, according to the embodiment, a connectivity check of a backup route or an auxiliary route using Ping is possible. Therefore, for example, since the connectivity check of the backup route by a monitoring device can be recognized, the problems when a route switching occurs can be resolved. In addition, setting of the network equipment is unnecessary, thus reducing the amount of work for implementation and eliminating human setting errors. Further, since there is no limit on the number of specified routes, a connectivity check can be performed regardless of the scale of the network.

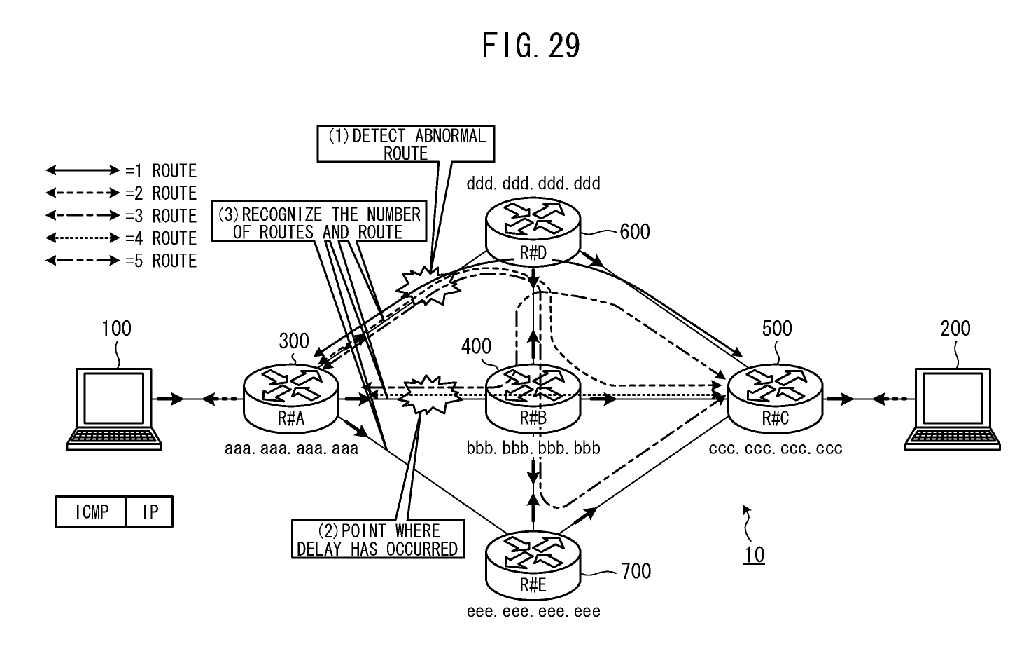

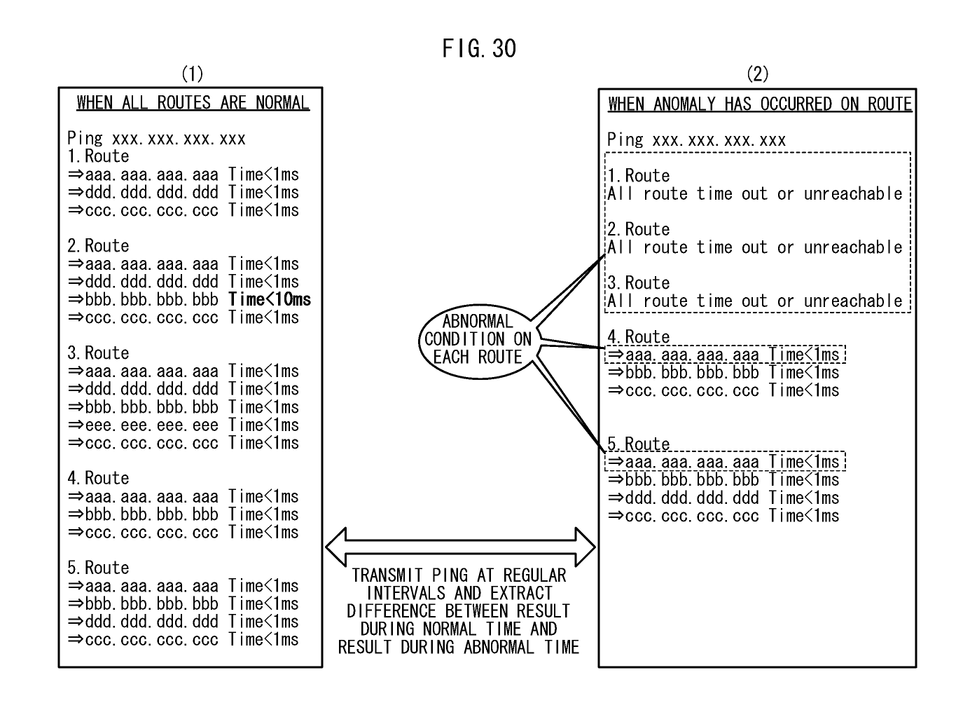

Furthermore, according to the embodiment, the following effects can be obtained. FIGS. 29 and 30 are diagrams illustrating effects according to the embodiment. For example, it is assumed that an anomaly had occurred on the communication route between the router 300 and the router 600 as shown in FIG. 29 (1). In this case, on the user interface section 101, as shown in FIG. 30 (2), the all-routes verification response packets have not been forwarded to the transmitting terminal 100 regarding “1 Route” to “3 Route”.

Therefore, regarding “1 Route” to “3 Route”, each message indicating that time is out is displayed. Accordingly, a communication route on which an anomaly had occurred can be easily detected. In addition, execution of a Ping command at regular intervals by the transmitting terminal 100 allows a difference between the display during normal time as shown in FIG. 30 (1) and the display during abnormal time as shown in FIG. 30 (2) to be extracted. Accordingly, a communication route in an anomaly state can be easily detected among a plurality of communication routes.

Further, if the time elapsed from when the all-routes verification request packet is transmitted to when the all-routes verification response packet is received is measured, and output together with the route information as shown in FIG. 30, the delay condition between hops of the operating route and the auxiliary route (all routes) can be monitored (see FIG. 29 (2)). Moreover, since a connectivity check can be performed for each communication route, the number of routes and the route information can be recognized (see FIG. 29 (3)).

The relaying method in the network system described in the embodiment may be achieved by executing a program that is provided in advance in a computer such as a personal computer and a workstation. In other words, programs that realize the functions of the transmitting terminal 100, the receiving terminal 200 and/or the router 500 described in the embodiment are prepared respectively to be executed by the computer. Each program is recorded on a computer readable recording medium such as a hard disk, flexible disk (FD), CD-ROM, MO and DVD, and read from the recording medium by a computer and executed. In addition, each program may be distributed through a network such as the Internet.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A relaying method for relaying a packet between a transmitter and a receiver connected to each other through a plurality of communication routes, comprising:
a request packet generation operation in which said transmitter generates a request packet for requesting a connectivity check for all communication routes between said receiver and said transmitter;
a request packet transmission operation in which said transmitter transmits the generated request packet to a relay;
a route information addition operation in which, when the request packet transmitted by said transmitter is received, said relay adds information representing the router itself to the received request packet as route information;
a request packet forwarding operation in which said relay forwards the request packet to which said route information has been added to each of all the communication routes between said receiver and said relay;
a response packet generation operation in which, when the request packet forwarded by said relay is received, said receiver generates a response packet into which the route information included in the received request packet has been transcribed;
a response packet transmission operation in which said receiver transmits the generated response packet to said transmitter via said relay;
a response packet forwarding operation in which, when the response packet transmitted by said receiver is received, said relay forwards the received response packet to said transmitter; and
a route information output operation in which, when the response packet forwarded by said relay is received, said transmitter outputs the route information included in the received response packet.

2. The relaying method according to claim 1, wherein in said response packet forwarding operation, when forwarding said response packet, said relay follows backward a route through which a request packet, which is the basis for said response packet, has been forwarded to forward said response packet based on the route information included in said response packet.

3. The relaying method according to claim 1, wherein in said route information addition operation, if information representing the router itself has already been included in said request packet before said relay adds said route information to said request packet, said relay discards said request packet.

4. The relaying method according to claim 1, further comprising:
a time measurement operation in which said transmitter measures an elapsed time since said request packet has been transmitted in said request packet transmission operation,
wherein in said route information output operation, if the elapsed time measured in said time measurement operation exceeds a predetermined time, said transmitter outputs information representing that there is no response to said request packet.

5. The relaying method according to claim 1, wherein in said route information output operation, said transmitter counts the number of times said response packet has been received, and if the counted number of times exceeds a predetermined number of times, outputs said route information.

6. A transmitter, comprising:
a request packet generator for generating a request packet for requesting a connectivity check for all communication routes between a receiver and the transmitter;
a request packet transmitter for transmitting the request packet generated by said request packet generator to a relay; and
a route information output section for, when a response packet forwarded by said relay is received, outputting route information included in the received response packet.

7. A receiver, comprising:
a response packet generator for, when a request packet is received for requesting a connectivity check for all communication routes between the receiver and a transmitter, generating a response packet into which route information included in the received request packet has been transcribed; and
a response packet transmitter for transmitting the response packet generated by said response packet generator to said transmitter via a relay.

8. A relay, comprising:
a route information adder for, when a request packet transmitted by a transmitter is received, adding information representing the router itself to the received request packet as route information;
a request packet forwarder for forwarding the request packet to which said route information has been added by said route information adder to each of all the communication routes between a receiver and the relay; and
a response packet forwarder for, when a response packet is received into which the route information included in the request packet forwarded by said request packet forwarder has been transcribed, forwarding the received response packet to said transmitter.

9. A relaying method, comprising:
generating a request packet at a transmitter for requesting a connectivity check for all communication routes between the transmitter and a receiver;
transmitting the generated request packet to a relay;
adding information representing the router to the received request packet at the relay as route information when the request packet is received;
forwarding the request packet with the route information to the receiver along all of the communication routes between the relay and the receiver;
receiving the request packet at the receiver;
generating a response packet at the receiver;
transcribing the route information included in the received request packet into the response packet;
transmitting the response packet to the transmitter via the relay;
forwarding the response packet to the transmitter at the relay;
receiving the response packet forwarded by the relay at the transmitter; and
outputting the route information included in the received response packet at the transmitter.
